(19) United States
(12) Patent Application Publication
(10) Pub. No.: US 2022/0398312 A1
(43) Pub. Date: Dec. 15, 2022

(54) SYSTEMS AND METHODS FOR IMPROVING EFFICIENCY OF METADATA PROCESSING

(71) Applicant: Dover Microsystems, Inc., Wayland, MA (US)

(72) Inventors: Andrew Sutherland, Portland, OR (US); Steven Milburn, Cranston, RI (US)

(73) Assignee: Dover Microsystems, Inc., Wayland, CA (US)

(21) Appl. No.: 17/774,799

(22) PCT Filed: Nov. 5, 2020
(86) PCT No.: PCT/US2020/059057

§ 371 Date: May 5, 2022

Related U.S. Application Data
(60) Provisional application No. 62/931,635, filed on Nov. 6, 2019.

(51) Int. Cl. G06F 21/55; G06F 12/0811

(52) U.S. Cl. CPC G06F 21/552; G06F 12/0811; G06F 2221/034; G06F 2212/6042

(57) ABSTRACT

Systems and methods for efficient metadata processing, for example, by resolving input patterns into binary representations ahead of time. In some embodiments, a plurality of input patterns may be identified, wherein an input pattern of the plurality of input patterns comprises a metadata label. A plurality of respective values may be selected for a plurality of variables, wherein the plurality of variables comprise a variable corresponding to the metadata label of the input pattern. A binary representation of the metadata label may be obtained based on the respective value of the variable.

### RELATED APPLICATIONS

This application claims the benefit under 35 U.S.C. § 119(e) of U.S. Provisional Patent Application Ser. No. 62/931,635, filed on Nov. 6, 2019, titled “SYSTEMS AND METHODS FOR IMPROVING EFFICIENCY OF METADATA PROCESSING,” bearing Attorney Docket No. D0821.70005US00, which is hereby incorporated by reference in its entirety.

### BACKGROUND

Computer security has become an increasingly urgent concern at all levels of society, from individuals to businesses to government institutions. For example, in 2015, security researchers identified a zero-day vulnerability that would have allowed an attacker to hack into a Jeep Cherokee's on-board computer system via the Internet and take control of the vehicle's dashboard functions, steering, brakes, and transmission. In 2017, the WannaCry ransomware attack was estimated to have affected more than 200,000 computers worldwide, causing at least hundreds of millions of dollars in economic losses. Notably, the attack crippled operations at several National Health Service hospitals in the UK. In the same year, a data breach at Equifax, a US consumer credit reporting agency, exposed person data such as full names, social security numbers, birth dates, addresses, driver's license numbers, credit card numbers, etc. That attack is reported to have affected over 140 million consumers.

Security professionals are constantly playing catch-up with attackers. As soon as a vulnerability is reported, security professionals rush to patch the vulnerability. Individuals and organizations that fail to patch vulnerabilities in a timely manner (e.g., due to poor governance and/or lack of resources) become easy targets for attackers.

Some security software monitors activities on a computer and/or within a network, and looks for patterns that may be indicative of an attack. Such an approach does not prevent malicious code from being executed in the first place. Often, the damage has been done by the time any suspicious pattern emerges.

### SUMMARY

In accordance with some embodiments, a computer-implemented method for resolving input patterns into binary representations is provided, comprising acts of: identifying a plurality of input patterns, wherein an input pattern of the plurality of input patterns comprises a metadata label; selecting a plurality of respective values for a plurality of variables, wherein the plurality of variables comprise a variable corresponding to the metadata label of the input pattern; and obtaining a binary representation of the metadata label based on the respective value of the variable.

In some embodiments, the method further comprises an act of constructing a plurality of constraints corresponding, respectively, to the plurality of input patterns; a constraint of the plurality of the constraints corresponds to the input pattern comprising the metadata label; the constraint references a variable corresponding to the metadata label; and selecting the plurality of respective values for the plurality of variables comprises solving, subject to the plurality of constraints, for the plurality of variables to obtain the plurality of respective values.

In some embodiments, selecting the plurality of respective values for the plurality of variables comprises using an optimization technique to select the plurality of respective values.

In accordance with some embodiments, a computer-implemented method for resolving metadata labels into binary representations is provided, comprising acts of: looking up a metadata label in a dictionary, the dictionary comprising a plurality of entries mapping metadata labels to respective binary representations; if the metadata label matches an entry in the dictionary, obtaining a binary representation to which the matching entry maps the metadata label; and if the metadata label does not match any entry in the dictionary, generating a new binary representation.

In accordance with some embodiments, a computer-implemented method for identifying input patterns is provided, comprising an act of: processing a policy rule to identify at least one input pattern, wherein: the policy rule comprises at least one condition on at least one input; the at least one input pattern comprises at least one metadata label corresponding to the at least one input; and the at least one metadata label satisfies the at least one condition on the at least one input.

In accordance with some embodiments, a computer-implemented method for processing a query input pattern is provided, comprising an act of: matching the query input pattern against a list of concrete rules, wherein: the query input pattern comprises a list of metadata labels <L₀, . . . , L_{S-1}> corresponding, respectively, to a list of inputs; each concrete rule of the list of concrete rules comprises a list of metadata labels <M₀, . . . , M_{S-1}> corresponding, respectively, to the list of inputs; the list of concrete rules is ordered according to a lexicographic ordering induced by a selected ordering on metadata labels; matching the query input pattern against the list of concrete rules comprises comparing <L₀, . . . , L_{S-1}> against a selected concrete rule R0 according to the lexicographic ordering; and a number of concrete rules R such that R is less than R0 according to the lexicographic ordering matches a number of concrete rules R such that R is greater than R0 according to the lexicographic ordering.

In accordance with some embodiments, a system is provided, comprising circuitry and/or one or more processors programmed by executable instructions, wherein the circuitry and/or the one or more programmed processors are configured to perform any of the methods described herein.

In accordance with some embodiments, at least one computer-readable medium is provided, having stored thereon at least one netlist for any of the circuitries described herein.

In accordance with some embodiments, at least one computer-readable medium is provided, having stored thereon at least one hardware description that, when synthesized, produces any of the netlists described herein.

In accordance with some embodiments, at least one computer-readable medium is provided, having stored thereon any of the executable instructions described herein.

### BRIEF DESCRIPTION OF DRAWINGS

FIG. 1 shows an illustrative hardware system 100 for enforcing policies, in accordance with some embodiments.

FIG. 2 shows an illustrative software system 200 for enforcing policies, in accordance with some embodiments.

FIG. 3 shows an illustrative finite state machine (FSM) 300, in accordance with some embodiments.

FIG. 4 shows an illustrative process 400 that may be used to identify input patterns, in accordance with some embodiments.

FIG. 5 shows an illustrative process 500 for resolving a metadata label into a binary representation, in accordance with some embodiments.

FIG. 6 shows an illustrative graph 600 that may be used to resolve a metadata label into a binary representation, in accordance with some embodiments.

FIG. 7 shows an illustrative process 700 for adaptively resolving metadata labels into binary representations, in accordance with some embodiments.

FIG. 8 shows an illustrative process 800 for resolving a batch of input patterns, in accordance with some embodiments.

FIG. 9 shows an illustrative process 900 for resolving a batch of input patterns, in accordance with some embodiments.

FIG. 10 shows an illustrative arrangement 1000 of concrete rules, in accordance with some embodiments.

FIG. 11 shows, schematically, an illustrative computer 1100 on which any aspect of the present disclosure may be implemented.

### DETAILED DESCRIPTION

This application may include subject matter related to that of International Patent Application No. PCT/US2019/016272, filed on Feb. 1, 2019, titled “SYSTEMS AND METHODS FOR SECURE INITIALIZATION,” bearing Attorney Docket No. D0821.70000WO00, which is hereby incorporated by reference in its entirety.

This application may include subject matter related to that of International Patent Application No. PCT/US2019/029880, filed on Apr. 30, 2019, titled “SYSTEMS AND METHODS FOR CHECKING SAFETY PROPERTIES,” bearing Attorney Docket No. D0821.70002WO00, which is hereby incorporated by reference in its entirety.

This application may include subject matter related to that of U.S. Provisional Application No. 62/794,499, filed on Jan. 18, 2019, titled “SYSTEMS AND METHODS FOR MATADATA CLASSIFICATION,” bearing Attorney Docket No. D0821.70013US00, which is hereby incorporated by reference in its entirety.

Many vulnerabilities exploited by attackers trace back to a computer architectural design where data and executable instructions are intermingled in a same memory. This intermingling allows an attacker to inject malicious code into a remote computer by disguising the malicious code as data. For instance, a program may allocate a buffer in a computer's memory to store data received via a network. If the program receives more data than the buffer can hold, but does not check the size of the received data prior to writing the data into the buffer, part of the received data would be written beyond the buffer's boundary, into adjacent memory. An attacker may exploit this behavior to inject malicious code into the adjacent memory. If the adjacent memory is allocated for executable code, the malicious code may eventually be executed by the computer.

Techniques have been proposed to make computer hardware more security aware. For instance, memory locations may be associated with metadata for use in enforcing security policies, and instructions may be checked for compliance with the security policies. For example, given an instruction to be executed, metadata associated with the instruction and/or metadata associated with one or more operands of the instruction may be checked to determine if the instruction should be allowed. Additionally, or alternatively, appropriate metadata may be associated with an output of the instruction.

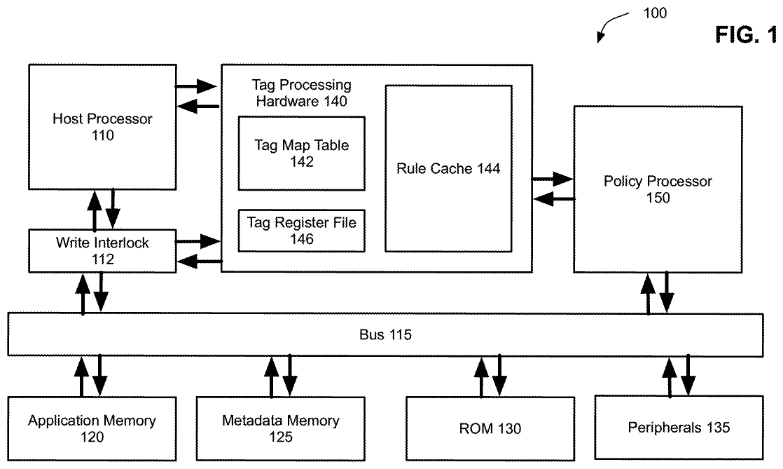

FIG. 1 shows an illustrative hardware system 100 for enforcing policies, in accordance with some embodiments. In this example, the system 100 includes a host processor 110, which may have any suitable instruction set architecture (ISA) such as a reduced instruction set computing (RISC) architecture or a complex instruction set computing (CISC) architecture. The host processor 110 may perform memory accesses via a write interlock 112. The write interlock 112 may be connected to a system bus 115 configured to transfer data between various components such as the write interlock 112, an application memory 120, a metadata memory 125, a read-only memory (ROM) 130, one or more peripherals 135, etc.

In some embodiments, data that is manipulated (e.g., modified, consumed, and/or produced) by the host processor 110 may be stored in the application memory 120. Such data is referred to herein as “application data,” as distinguished from metadata used for enforcing policies. The latter may be stored in the metadata memory 125. It should be appreciated that application data may include data manipulated by an operating system (OS), instructions of the OS, data manipulated by one or more user applications, and/or instructions of the one or more user applications.

In some embodiments, the application memory 120 and the metadata memory 125 may be physically separate, and the host processor 110 may have no access to the metadata memory 125. In this manner, even if an attacker succeeds in injecting malicious code into the application memory 120 and causing the host processor 110 to execute the malicious code, the metadata memory 125 may not be affected. However, it should be appreciated that aspects of the present disclosure are not limited to storing application data and metadata on physically separate memories. Additionally, or alternatively, metadata may be stored in a same memory as application data, and a memory management component may be used that implements an appropriate protection scheme to prevent instructions executing on the host processor 110 from modifying the metadata. Additionally, or alternatively, metadata may be intermingled with application data in a same memory, and one or more policies may be used to protect the metadata.

In some embodiments, tag processing hardware 140 may be provided to ensure that instructions being executed by the host processor 110 comply with one or more policies. The tag processing hardware 140 may include any suitable circuit component or combination of circuit components. For instance, the tag processing hardware 140 may include a tag map table 142 that maps addresses in the application memory 120 to addresses in the metadata memory 125. For example, the tag map table 142 may map an address X in the application memory 120 to an address Y in the metadata memory 125. A value stored at the address Y is sometimes referred to herein as a “metadata tag.”

In some embodiments, a value stored at the address Y may in turn be an address Z. Such indirection may be repeated any suitable number of times, and may eventually lead to a data structure in the metadata memory 125 for storing metadata. Such metadata, as well as any intermediate address (e.g., the address Z), are also referred to herein as “metadata tags.”

It should be appreciated that aspects of the present disclosure are not limited to a tag map table that stores addresses in a metadata memory. In some embodiments, a tag map table entry itself may store metadata, so that the tag processing hardware 140 may be able to access the metadata without performing a memory operation. In some embodiments, a tag map table entry may store a selected bit pattern, where a first portion of the bit pattern may encode metadata, and a second portion of the bit pattern may encode an address in a metadata memory where further metadata may be stored. This may provide a desired balance between speed and expressivity. For instance, the tag processing hardware 140 may be able to check certain policies quickly, using only the metadata stored in the tag map table entry itself. For other policies with more complex rules, the tag processing hardware 140 may access the further metadata stored in the metadata memory 125.

Referring again to FIG. 1, by mapping application memory addresses to metadata memory addresses, the tag map table 142 may create an association between application data and metadata that describes the application data. In one example, metadata stored at the metadata memory address Y and thus associated with application data stored at the application memory address X may indicate that the application data may be readable, writable, and/or executable. In another example, metadata stored at the metadata memory address Y and thus associated with application data stored at the application memory address X may indicate a type of the application data (e.g., integer, pointer, 16-bit word, 32-bit word, etc.). Depending on a policy to be enforced, any suitable metadata relevant for the policy may be associated with a piece of application data.

In some embodiments, a metadata memory address Z may be stored at the metadata memory address Y. Metadata to be associated with the application data stored at the application memory address X may be stored at the metadata memory address Z, instead of (or in addition to) the metadata memory address Y. For instance, a binary representation of a metadata label RED may be stored at the metadata memory address Z. By storing the metadata memory address Z in the metadata memory address Y, the application data stored at the application memory address X may be tagged RED.

In this manner, the binary representation of the metadata label RED may be stored only once in the metadata memory 125. For instance, if application data stored at another application memory address X′ is also to be tagged RED, the tag map table 142 may map the application memory address X′ to a metadata memory address Y′ where the metadata memory address Z is also stored.

Moreover, in this manner, tag update may be simplified. For instance, if the application data stored at the application memory address X is to be tagged BLUE at a subsequent time, a metadata memory address Z′ may be written at the metadata memory address Y, to replace the metadata memory address Z, and a binary representation of the metadata label BLUE may be stored at the metadata memory address Z′.

Thus, the inventor has recognized and appreciated that a chain of metadata memory addresses of any suitable length N may be used for tagging, including N=0 (e.g., where a binary representation of a metadata label is stored at the metadata memory address Y itself).

The association between application data and metadata (also referred to herein as “tagging”) may be done at any suitable level of granularity, and/or variable granularity. For instance, tagging may be done on a word-by-word basis. Additionally, or alternatively, a region in memory may be mapped to a single metadata tag, so that all words in that region are associated with the same metadata. This may advantageously reduce a size of the tag map table 142 and/or the metadata memory 125. For example, a single metadata tag may be maintained for an entire address range, as opposed to maintaining multiple metadata tags corresponding, respectively, to different addresses in the address range.

In some embodiments, the tag processing hardware 140 may be configured to apply one or more rules to metadata associated with an instruction and/or metadata associated with one or more operands of the instruction to determine if the instruction should be allowed. For instance, the host processor 110 may fetch and execute an instruction, and may queue a result of executing the instruction into the write interlock 112. Before the result is written back into the application memory 120, the host processor 110 may send, to the tag processing hardware 140, an instruction type (e.g., opcode), an address where the instruction is stored, one or more memory addresses referenced by the instruction, and/or one or more register identifiers. Such a register identifier may identify a register used by the host processor 110 in executing the instruction, such as a register for storing an operand or a result of the instruction.

In some embodiments, destructive read instructions may be queued in addition to, or instead of, write instructions. For instance, subsequent instructions attempting to access a target address of a destructive read instruction may be queued in a memory region that is not cached. If and when it is determined that the destructive read instruction should be allowed, the queued instructions may be loaded for execution.

In some embodiments, a destructive read instruction may be allowed to proceed, and data read from a target address may be captured in a buffer. If and when it is determined that the destructive read instruction should be allowed, the data captured in the buffer may be discarded. If and when it is determined that the destructive read instruction should not be allowed, the data captured in the buffer may be restored to the target address. Additionally, or alternatively, a subsequent read may be serviced by the buffered data.

It should be appreciated that aspects of the present disclosure are not limited to performing metadata processing on instructions that have been executed by a host processor, such as instructions that have been retired by the host processor's execution pipeline. In some embodiments, metadata processing may be performed on instructions before, during, and/or after the host processor's execution pipeline.

In some embodiments, given an address received from the host processor 110 (e.g., an address where an instruction is stored, or an address referenced by an instruction), the tag processing hardware 140 may use the tag map table 142 to identify a corresponding metadata tag. Additionally, or alternatively, for a register identifier received from the host processor 110, the tag processing hardware 140 may access a metadata tag from a tag register file 146 within the tag processing hardware 140.

In some embodiments, if an application memory address does not have a corresponding entry in the tag map table 142, the tag processing hardware 140 may send a query to a policy processor 150. The query may include the application memory address in question, and the policy processor 150 may return a metadata tag for that application memory address. Additionally, or alternatively, the policy processor 150 may create a new tag map entry for an address range including the application memory address. In this manner, the appropriate metadata tag may be made available, for future reference, in the tag map table 142 in association with the application memory address in question.

In some embodiments, the tag processing hardware 140 may send a query to the policy processor 150 to check if an instruction executed by the host processor 110 should be allowed. The query may include one or more inputs, such as an instruction type (e.g., opcode) of the instruction, a metadata tag for a program counter, a metadata tag for an application memory address from which the instruction is fetched (e.g., a word in memory to which the program counter points), a metadata tag for a register in which an operand of the instruction is stored, and/or a metadata tag for an application memory address referenced by the instruction. In one example, the instruction may be a load instruction, and an operand of the instruction may be an application memory address from which application data is to be loaded. The query may include, among other things, a metadata tag for a register in which the application memory address is stored, as well as a metadata tag for the application memory address itself. In another example, the instruction may be an arithmetic instruction, and there may be two operands. The query may include, among other things, a first metadata tag for a first register in which a first operand is stored, and a second metadata tag for a second register in which a second operand is stored.

It should also be appreciated that aspects of the present disclosure are not limited to performing metadata processing on a single instruction at a time. In some embodiments, multiple instructions in a host processor's ISA may be checked together as a bundle, for example, via a single query to the policy processor 150. Such a query may include more inputs to allow the policy processor 150 to check all of the instructions in the bundle. Similarly, a CISC instruction, which may correspond semantically to multiple operations, may be checked via a single query to the policy processor 150, where the query may include sufficient inputs to allow the policy processor 150 to check all of the constituent operations within the CISC instruction.

In some embodiments, the policy processor 150 may include a configurable processing unit, such as a microprocessor, a field-programmable gate array (FPGA), and/or any other suitable circuitry. The policy processor 150 may have loaded therein one or more policies that describe allowed operations of the host processor 110. In response to a query from the tag processing hardware 140, the policy processor 150 may evaluate one or more of the policies to determine if an instruction in question should be allowed. For instance, the tag processing hardware 140 may send an interrupt signal to the policy processor 150, along with one or more inputs relating to the instruction in question (e.g., as described above). The policy processor 150 may store the inputs of the query in a working memory (e.g., in one or more queues) for immediate or deferred processing. For example, the policy processor 150 may prioritize processing of queries in some suitable manner (e.g., based on a priority flag associated with each query).

In some embodiments, the policy processor 150 may evaluate one or more policies on one or more inputs (e.g., one or more input metadata tags) to determine if an instruction in question should be allowed. If the instruction is not to be allowed, the policy processor 150 may so notify the tag processing hardware 140. If the instruction is to be allowed, the policy processor 150 may compute one or more outputs (e.g., one or more output metadata tags) to be returned to the tag processing hardware 140. As one example, the instruction may be a store instruction, and the policy processor 150 may compute an output metadata tag for an application memory address to which application data is to be stored. As another example, the instruction may be an arithmetic instruction, and the policy processor 150 may compute an output metadata tag for a register for storing a result of executing the arithmetic instruction.

In some embodiments, the policy processor 150 may be programmed to perform one or more tasks in addition to, or instead of, those relating to evaluation of policies. For instance, the policy processor 150 may perform tasks relating to tag initialization, boot loading, application loading, memory management (e.g., garbage collection) for the metadata memory 125, logging, debugging support, and/or interrupt processing. One or more of these tasks may be performed in the background (e.g., between servicing queries from the tag processing hardware 140).

In some embodiments, the tag processing hardware 140 may include a rule cache 144 for mapping one or more inputs to a decision and/or one or more outputs. For instance, a query into the rule cache 144 may be similarly constructed as a query to the policy processor 150 to check if an instruction executed by the host processor 110 should be allowed. If there is a cache hit, the rule cache 144 may output a decision as to whether to the instruction should be allowed, and/or one or more output metadata tags (e.g., as described above in connection with the policy processor 150). Such a mapping in the rule cache 144 may be created using a query response from the policy processor 150. However, that is not required, as in some embodiments, one or more mappings may be installed into the rule cache 144 ahead of time.

In some embodiments, the rule cache 144 may be used to provide a performance enhancement. For instance, before querying the policy processor 150 with one or more input metadata tags, the tag processing hardware 140 may first query the rule cache 144 with the one or more input metadata tags. In case of a cache hit, the tag processing hardware 140 may proceed with a decision and/or one or more output metadata tags from the rule cache 144, without querying the policy processor 150. This may provide a significant speedup. In case of a cache miss, the tag processing hardware 140 may query the policy processor 150, and may install a response from the policy processor 150 into the rule cache 144 for potential future use.

In some embodiments, the tag processing hardware 140 may form a hash key based on one or more input metadata tags, and may present the hash key to the rule cache 144. In case of a cache miss, the tag processing hardware 140 may send an interrupt signal to the policy processor 150. In response to the interrupt signal, the policy processor 150 may fetch metadata from one or more input registers (e.g., where the one or more input metadata tags are stored), process the fetched metadata, and write one or more results to one or more output registers. The policy processor 150 may then signal to the tag processing hardware 140 that the one or more results are available.

In some embodiments, if the tag processing hardware 140 determines that an instruction in question should be allowed (e.g., based on a hit in the rule cache 144, or a miss in the rule cache 144, followed by a response from the policy processor 150 indicating no policy violation has been found), the tag processing hardware 140 may indicate to the write interlock 112 that a result of executing the instruction may be written back to memory. Additionally, or alternatively, the tag processing hardware 140 may update the metadata memory 125, the tag map table 142, and/or the tag register file 146 with one or more output metadata tags (e.g., as received from the rule cache 144 or the policy processor 150). As one example, for a store instruction, the metadata memory 125 may be updated based on an address translation by the tag map table 142. For instance, an application memory address referenced by the store instruction may be used to look up a metadata memory address from the tag map table 142, and metadata received from the rule cache 144 or the policy processor 150 may be stored to the metadata memory 125 at the metadata memory address. As another example, where metadata to be updated is stored in an entry in the tag map table 142 (as opposed to being stored in the metadata memory 125), that entry in the tag map table 142 may be updated. As another example, for an arithmetic instruction, an entry in the tag register file 146 corresponding to a register used by the host processor 110 for storing a result of executing the arithmetic instruction may be updated with an appropriate metadata tag.

In some embodiments, if the tag processing hardware 140 determines that the instruction in question represents a policy violation (e.g., based on a miss in the rule cache 144, followed by a response from the policy processor 150 indicating a policy violation has been found), the tag processing hardware 140 may indicate to the write interlock 112 that a result of executing the instruction should be discarded, instead of being written back to memory. Additionally, or alternatively, the tag processing hardware 140 may send an interrupt to the host processor 110. In response to receiving the interrupt, the host processor 110 may switch to any suitable violation processing code. For example, the host processor 100 may halt, reset, log the violation and continue, perform an integrity check on application code and/or application data, notify an operator, etc.

In some embodiments, the rule cache 144 may be implemented with a hash function and a designated portion of a memory (e.g., the metadata memory 125). For instance, a hash function may be applied to one or more inputs to the rule cache 144 to generate an address in the metadata memory 125. A rule cache entry corresponding to the one or more inputs may be stored to, and/or retrieved from, that address in the metadata memory 125. Such an entry may include the one or more inputs and/or one or more corresponding outputs, which may be computed from the one or more inputs at run time, load time, link time, or compile time.

In some embodiments, the tag processing hardware 140 may include one or more configuration registers. Such a register may be accessible (e.g., by the policy processor 150) via a configuration interface of the tag processing hardware 140. In some embodiments, the tag register file 146 may be implemented as configuration registers. Additionally, or alternatively, there may be one or more application configuration registers and/or one or more metadata configuration registers.

Although details of implementation are shown in FIG. 1 and discussed above, it should be appreciated that aspects of the present disclosure are not limited to the use of any particular component, or combination of components, or to any particular arrangement of components. For instance, in some embodiments, one or more functionalities of the policy processor 150 may be performed by the host processor 110. As an example, the host processor 110 may have different operating modes, such as a user mode for user applications and a privileged mode for an operating system. Policy-related code (e.g., tagging, evaluating policies, etc.) may run in the same privileged mode as the operating system, or a different privileged mode (e.g., with even more protection against privilege escalation).

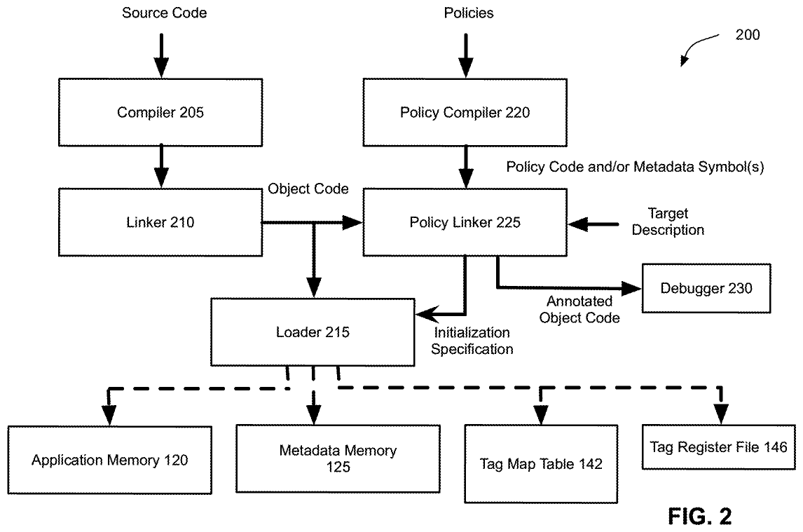

FIG. 2 shows an illustrative software system 200 for enforcing policies, in accordance with some embodiments. For instance, the software system 200 may be programmed to generate executable code and/or load the executable code into the illustrative hardware system 100 in the example of FIG. 1.

In the example shown in FIG. 2, the software system 200 includes a software toolchain having a compiler 205, a linker 210, and a loader 215. The compiler 205 may be programmed to process source code into executable code, where the source code may be in a higher-level language and the executable code may be in a lower level language. The linker 210 may be programmed to combine multiple object files generated by the compiler 205 into a single object file to be loaded by the loader 215 into memory (e.g., the illustrative application memory 120 in the example of FIG. 1). Although not shown, the object file output by the linker 210 may be converted into a suitable format and stored in persistent storage, such as flash memory, hard disk, read-only memory (ROM), etc. The loader 215 may retrieve the object file from the persistent storage, and load the object file into random-access memory (RAM).

In some embodiments, the compiler 205 may be programmed to generate information for use in enforcing policies. For instance, as the compiler 205 translates source code into executable code, the compiler 205 may generate information regarding data types, program semantics and/or memory layout. As one example, the compiler 205 may be programmed to mark a boundary between one or more instructions of a function and one or more instructions that implement calling convention operations (e.g., passing one or more parameters from a caller function to a callee function, returning one or more values from the callee function to the caller function, storing a return address to indicate where execution is to resume in the caller function's code when the callee function returns control back to the caller function, etc.). Such boundaries may be used, for instance, during initialization to tag certain instructions as function prologue or function epilogue. At run time, a stack policy may be enforced so that, as function prologue instructions execute, certain locations in a call stack (e.g., where a return address is stored) may be tagged as FRAME locations, and as function epilogue instructions execute, the FRAME metadata tags may be removed. The stack policy may indicate that instructions implementing a body of the function (as opposed to function prologue and function epilogue) only have read access to FRAME locations. This may prevent an attacker from overwriting a return address and thereby gaining control.

As another example, the compiler 205 may be programmed to perform control flow analysis, for instance, to identify one or more control transfer points and respective destinations. Such information may be used in enforcing a control flow policy. As yet another example, the compiler 205 may be programmed to perform type analysis, for example, by applying type labels such as Pointer, Integer, Floating-Point Number, etc. Such information may be used to enforce a policy that prevents misuse (e.g., using a floating-point number as a pointer).

Although not shown in FIG. 2, the software system 200 may, in some embodiments, include a binary analysis component programmed to take, as input, object code produced by the linker 210 (as opposed to source code), and perform one or more analyses similar to those performed by the compiler 205 (e.g., control flow analysis, type analysis, etc.).

In the example of FIG. 2, the software system 200 further includes a policy compiler 220 and a policy linker 225. The policy compiler 220 may be programmed to translate one or more policies written in a policy language into policy code. For instance, the policy compiler 220 may output policy code in C or some other suitable programming language. Additionally, or alternatively, the policy compiler 220 may output one or more metadata labels referenced by the one or more policies. At initialization, such a metadata label may be associated with one or more memory locations, registers, and/or other machine state of a target system, and may be resolved into a binary representation of metadata to be loaded into a metadata memory or some other hardware storage (e.g., registers) of the target system. As discussed above, such a binary representation of metadata, or a pointer to a location at which the binary representation is stored, is sometimes referred to herein as a “metadata tag.”

It should be appreciated that aspects of the present disclosure are not limited to resolving metadata labels at load time. In some embodiments, one or more metadata labels may be resolved statically (e.g., at compile time or link time). For example, the policy compiler 220 may process one or more applicable policies, and resolve one or more metadata labels defined by the one or more policies into a statically-determined binary representation. Additionally, or alternatively, the policy linker 225 may resolve one or more metadata labels into a statically-determined binary representation, or a pointer to a data structure storing a statically-determined binary representation. The inventors have recognized and appreciated that resolving metadata labels statically may advantageously reduce load time processing. However, aspects of the present disclosure are not limited to resolving metadata labels in any particular manner.

In some embodiments, the policy linker 225 may be programmed to process object code (e.g., as output by the linker 210), policy code (e.g., as output by the policy compiler 220), and/or a target description, to output an initialization specification. The initialization specification may be used by the loader 215 to securely initialize a target system having one or more hardware components (e.g., the illustrative hardware system 100 in the example of FIG. 1) and/or one or more software components (e.g., an operating system, one or more user applications, etc.).

In some embodiments, the target description may include descriptions of a plurality of named entities. A named entity may represent a component of a target system. As one example, a named entity may represent a hardware component, such as a configuration register, a program counter, a register file, a timer, a status flag, a memory transfer unit, an input/output device, etc. As another example, a named entity may represent a software component, such as a function, a module, a driver, a service routine, etc.

In some embodiments, the policy linker 225 may be programmed to search the target description to identify one or more entities to which a policy pertains. For instance, the policy may map certain entity names to corresponding metadata labels, and the policy linker 225 may search the target description to identify entities having those entity names. The policy linker 225 may identify descriptions of those entities from the target description, and use the descriptions to annotate, with appropriate metadata labels, the object code output by the linker 210. For instance, the policy linker 225 may apply a Read label to a .rodata section of an Executable and Linkable Format (ELF) file, a Read label and a Write label to a .data section of the ELF file, and an Execute label to a .text section of the ELF file. Such information may be used to enforce a policy for memory access control and/or executable code protection (e.g., by checking read, write, and/or execute privileges).

It should be appreciated that aspects of the present disclosure are not limited to providing a target description to the policy linker 225. In some embodiments, a target description may be provided to the policy compiler 220, in addition to, or instead of, the policy linker 225. The policy compiler 220 may check the target description for errors. For instance, if an entity referenced in a policy does not exist in the target description, an error may be flagged by the policy compiler 220. Additionally, or alternatively, the policy compiler 220 may search the target description for entities that are relevant for one or more policies to be enforced, and may produce a filtered target description that includes entities descriptions for the relevant entities only. For instance, the policy compiler 220 may match an entity name in an “init” statement of a policy to be enforced to an entity description in the target description, and may remove from the target description (or simply ignore) entity descriptions with no corresponding “init” statement.

In some embodiments, the loader 215 may initialize a target system based on an initialization specification produced by the policy linker 225. For instance, referring to the example of FIG. 1, the loader 215 may load data and/or instructions into the application memory 120, and may use the initialization specification to identify metadata labels associated with the data and/or instructions being loaded into the application memory 120. The loader 215 may resolve the metadata labels in the initialization specification into respective binary representations. However, it should be appreciated that aspects of the present disclosure are not limited to resolving metadata labels at load time. In some embodiments, a universe of metadata labels may be known during policy linking, and therefore metadata labels may be resolved at that time, for example, by the policy linker 225. This may advantageously reduce load time processing of the initialization specification.

In some embodiments, the policy linker 225 and/or the loader 215 may maintain a mapping of binary representations of metadata back to human readable versions of metadata labels. Such a mapping may be used, for example, by a debugger 230. For instance, in some embodiments, the debugger 230 may be provided to display a human readable version of an initialization specification, which may list one or more entities and, for each entity, a set of one or more metadata symbols associated with the entity. Additionally, or alternatively, the debugger 230 may be programmed to display assembly code annotated with metadata labels, such as assembly code generated by disassembling object code annotated with metadata labels. During debugging, the debugger 230 may halt a program during execution, and allow inspection of entities and/or metadata tags associated with the entities, in human readable form. For instance, the debugger 230 may allow inspection of entities involved in a policy violation and/or metadata tags that caused the policy violation. The debugger 230 may do so using the mapping of binary representations of metadata back to metadata labels.

In some embodiments, a conventional debugging tool may be extended to allow review of issues related to policy enforcement, for example, as described above. Additionally, or alternatively, a stand-alone policy debugging tool may be provided.

In some embodiments, the loader 215 may load the binary representations of the metadata labels into the metadata memory 125, and may record the mapping between application memory addresses and metadata memory addresses in the tag map table 142. For instance, the loader 215 may create an entry in the tag map table 142 that maps an application memory address where an instruction is stored in the application memory 120, to a metadata memory address where metadata associated with the instruction is stored in the metadata memory 125. Additionally, or alternatively, the loader 215 may store metadata in the tag map table 142 itself (as opposed to the metadata memory 125), to allow access without performing any memory operation.

In some embodiments, the loader 215 may initialize the tag register file 146 in addition to, or instead of, the tag map table 142. For instance, the tag register file 146 may include a plurality of registers corresponding, respectively, to a plurality of entities. The loader 215 may identify, from the initialization specification, metadata associated with the entities, and store the metadata in the respective registers in the tag register file 146.

Referring again to the example of FIG. 1, the loader 215 may, in some embodiments, load policy code (e.g., as output by the policy compiler 220) into the metadata memory 125 for execution by the policy processor 150. Additionally, or alternatively, a separate memory (not shown in FIG. 1) may be provided for use by the policy processor 150, and the loader 215 may load policy code and/or associated data into the separate memory.

In some embodiments, a metadata label may be based on multiple metadata symbols. For instance, an entity may be subject to multiple policies, and may therefore be associated with different metadata symbols corresponding, respectively, to the different policies. The inventors have recognized and appreciated that it may be desirable that a same set of metadata symbols be resolved by the loader 215 to a same binary representation (which is sometimes referred to herein as a “canonical” representation). For instance, a metadata label {A, B, C} and a metadata label {B, A, C} may be resolved by the loader 215 to a same binary representation. In this manner, metadata labels that are syntactically different but semantically equivalent may have the same binary representation.

The inventors have further recognized and appreciated it may be desirable to ensure that a binary representation of metadata is not duplicated in metadata storage. For instance, as discussed above, the illustrative rule cache 144 in the example of FIG. 1 may map input metadata tags to output metadata tags, and, in some embodiments, the input metadata tags may be metadata memory addresses where binary representations of metadata are stored, as opposed to the binary representations themselves. The inventors have recognized and appreciated that if a same binary representation of metadata is stored at two different metadata memory addresses X and Y, the rule cache 144 may not recognize an input pattern having the metadata memory address Y as matching a stored mapping having the metadata memory address X. This may result in a large number of unnecessary rule cache misses, which may degrade system performance.

Moreover, the inventor has recognized and appreciated that having a one-to-one correspondence between binary representations of metadata and their storage locations may facilitate metadata comparison. For instance, equality between two pieces of metadata may be determined simply by comparing metadata memory addresses, as opposed to comparing binary representations of metadata. This may result in significant performance improvement, especially where the binary representations are large (e.g., many metadata symbols packed into a single metadata label).

Accordingly, in some embodiments, the loader 215 may, prior to storing a binary representation of metadata (e.g., into the illustrative metadata memory 125 in the example of FIG. 1), check if the binary representation of metadata has already been stored. If the binary representation of metadata has already been stored, instead of storing it again at a different storage location, the loader 215 may refer to the existing storage location. Such a check may be done at startup and/or when a program is loaded subsequent to startup (with or without dynamic linking).

Additionally, or alternatively, a similar check may be performed when a binary representation of metadata is created as a result of evaluating one or more policies (e.g., by the illustrative policy processor 150 in the example of FIG. 1). If the binary representation of metadata has already been stored, a reference to the existing storage location may be used (e.g., installed in the illustrative rule cache 144 in the example of FIG. 1).

In some embodiments, the loader 215 may create a hash table mapping hash values to storage locations. Before storing a binary representation of metadata, the loader 215 may use a hash function to reduce the binary representation of metadata into a hash value, and check if the hash table already contains an entry associated with the hash value. If so, the loader 215 may determine that the binary representation of metadata has already been stored, and may retrieve, from the entry, information relating to the binary representation of metadata (e.g., a pointer to the binary representation of metadata, or a pointer to that pointer). If the hash table does not already contain an entry associated with the hash value, the loader 215 may store the binary representation of metadata (e.g., to a register or a location in a metadata memory), create a new entry in the hash table in association with the hash value, and store appropriate information in the new entry (e.g., a register identifier, a pointer to the binary representation of metadata in the metadata memory, a pointer to that pointer, etc.). However, it should be appreciated that aspects of the present disclosure are not limited to the use of a hash table for keeping track of binary representations of metadata that have already been stored. Additionally, or alternatively, other data structures may be used, such as a graph data structure, an ordered list, an unordered list, etc. Any suitable data structure or combination of data structures may be selected based on any suitable criterion or combination of criteria, such as access time, memory usage, etc.

It should be appreciated that the techniques introduced above and/or discussed in greater detail below may be implemented in any of numerous ways, as these techniques are not limited to any particular manner of implementation. Examples of implementation details are provided herein solely for purposes of illustration. Furthermore, the techniques disclosed herein may be used individually or in any suitable combination, as aspects of the present disclosure are not limited to any particular technique or combination of techniques.

For instance, while examples are discussed herein that include a compiler (e.g., the illustrative compiler 205 and/or the illustrative policy compiler 220 in the example of FIG. 2), it should be appreciated that aspects of the present disclosure are not limited to using a compiler. In some embodiments, a software toolchain may be implemented as an interpreter. For example, a lazy initialization scheme may be implemented, where one or more default labels (e.g., DEFAULT, PLACEHOLDER, etc.) may be used for tagging at startup, and a policy processor (e.g., the illustrative policy processor 150 in the example of FIG. 1) may evaluate one or more policies and resolve the one or more default labels in a just-in-time manner.

In some embodiments, a finite state machine (FSM) may include one or more states and/or one or more transitions. A transition may have a source state and a target state. The source state and the target state may be the same state, or different states. Pictorially, an FSM may be represented as a directed graph in which nodes represent states and edges represent transitions between states.

The inventors have recognized and appreciated that state machines provide a natural way to express desired behavior of a system. For instance, a safety property may be expressed based on a set of states that are designated as being safe, and/or a set of transitions that are designated as being allowed. An allowed transition may be such that, if a system starts in a safe state and takes the allowed transition, the system may end in a safe state (which may be the same as, or different from, the start state). In this manner, a formal proof may be given that the safety property will always be satisfied as long as the system is initialized to a safe state and only takes allowed transitions.

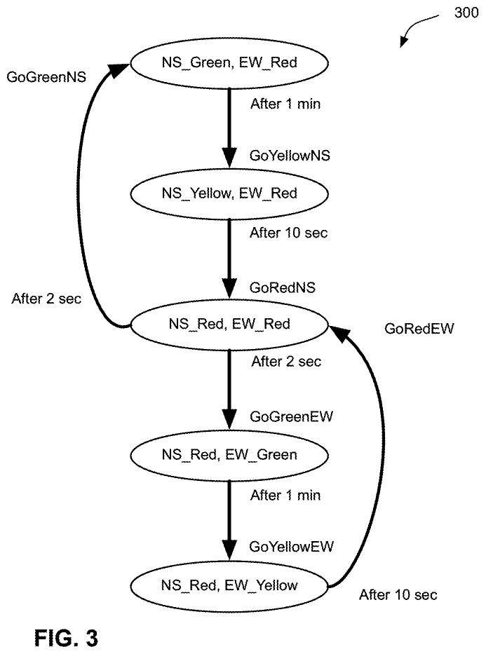

FIG. 3 shows an illustrative FSM 300, in accordance with some embodiments. For instance, the FSM 300 may represent a safety policy for a traffic light controller at a four-way intersection, where a light facing north and a light facing south may always show a same color, and likewise for a light facing east and a light facing west. The safety policy may indicate that if the north-south lights are not red (e.g., green or yellow), then the east-west lights must be red, and vice versa. Thus, the north-south lights and the east-west lights may never be all green simultaneously.

In the example of FIG. 3, the FSM 300 has two state variables: color of the north-south lights and color of the east-west lights. Each state variable may have three possible values: red, yellow, and green. The green-yellow, yellow-green, yellow-yellow and green-green states do not appear in FIG. 3 because such states are considered to be safety violations in this example. Thus, there may be only five safe states.

In some embodiments, the FSM 300 may have transitions that each represent a set of lights turning a selected color. For instance, after the FSM 300 has been in the green-red state for one minute, a transition may take place, representing the north-south lights turning from green to yellow, while the east-west lights remain red. This may cause the FSM 300 to enter in the yellow-red state.

In some embodiments, the FSM 300 may be translated into a policy. For example, the policy may include metadata symbols that correspond to values of state variables of the FSM 300. At run time, a metadata tag encoding one or more of these metadata symbols may be written to a memory location (e.g., a location in the illustrative metadata memory 125 in the example of FIG. 1) accessible to tag processing hardware (e.g., the illustrative tag processing hardware 140). For instance, one or more of these metadata symbols may be written to a memory location allocated for a metadata variable (e.g., an environment variable) maintained by the tag processing hardware 140 for policy checking purposes. Examples of state metadata symbols for the FSM 300 may include the following.

| metadata: | |
|---|---|
| // Metadata to represent light states | |
| data (Data) NS__T<fixed> = NS_Red | |
| | \| NS_Yellow |
| | \| NS_Green |
| data (Data) EW_T<fixed> = EW_Red | |
| | \| EW_Yellow |
| | \| EW_Green |

In this example, each value of each state variable is assigned a metadata symbol. Thus, a state of the FSM 300 may be represented as a pair of symbols, such as [NS_Red, EW_Green]. However, that is not required. In some embodiments, individual symbols may be used for combined colors, such as NS_Red & EW_Green.

Additionally, or alternatively, the policy may include metadata symbols that correspond to transitions in the FSM 300. At run time, one or more of these metadata symbols may be used to label application code executed by the traffic light controller. For instance, one or more of these metadata symbols may be written to a metadata memory location (e.g., a location in the illustrative metadata memory 125 in the example of FIG. 1) accessible to tag processing hardware (e.g., the illustrative tag processing hardware 140). The metadata memory location may be associated (e.g., via the illustrative tag map table 142) with an application memory location (e.g., a location in the illustrative application memory 120). The application code to be labeled by the one or more metadata symbols may be stored at the application memory location. Examples of transition metadata symbols for the FSM 300 may include the following.

| metadata: | |
|---|---|
| // Metadata to label code functions | |
| data (Instruction) Transition_T<fixed> = GoGreenNS | |
| | \| GoGreenEW |
| | \| GoRedNS |
| | \| GoRedEW |
| | \| GoYellowNS |
| | \| GoYellowEW |

In some embodiments, transitions in the FSM 300 may be translated into policy rules, such as one or more of the following policy rules.

```
policy:
    signalSafety =
    rule_1 (code == [+GoGreenNS], env == [NS_Red, EW_Red] ->
      env = {NS_Green, EW_Red})
  \hat{ } rule_2 (code == [+GoGreenEW], env == [NS_Red, EW_Red] ->
      env = {NS_Red, EW_Green})
  \hat{ } rule_3 (code == [+GoYellowNS], env == [NS_Green, EW_Red] ->
      env = {NS_Yellow, EW_Red})
  \hat{ } rule_4 (code == [+GoYellowEW], env == [NS_Red, EW_Green] ->
      env = {NS_Red, EW_Yellow})
  \hat{ } rule_5 (code == [+GoRedNS], env == [NS_Yellow, EW_Red] ->
      env = {NS_Red, EW_Red})
  \hat{ } rule_6 (code == [+GoRedEW], env == [NS_Red, EW_Yellow] ->
      env = {NS_Red, EW_Red})
  \hat{ } rule_self (code == [-GoGreenNS, -GoGreenEW,
```

-GoYellowNS, -GoYellowEW,
-GoRedNS, -GoRedEW], env == _ ->

env = env)

In this example, a policy rule may start with a rule name (e.g., “rule_1”), which may simply identify the policy rule for debugging purposes.

In some embodiments, the “code== . . . ” portion of the policy rule may indicate one or more transition metadata symbols (e.g., “GoGreenNS”). At run time, the tag processing hardware 140 may check if a metadata label associated with an instruction executed by a host processor (e.g., the illustrative host processor 110) matches the one or more transition metadata symbols indicated in the “code== . . . ” portion of the policy rule.

In some embodiments, the “env== . . . ” portion of the policy rule (before the right arrow) may indicate one or more state metadata symbols (e.g., “NS_Red, EW_Red”). At run time, the tag processing hardware 140 may check if a metadata label associated with a program counter matches the one or more state metadata symbols indicated in the “env== . . . ” portion of the policy rule.

In the last policy rule of this example, the underscore character may indicate a wildcard. For instance, the expression “env==_” may indicate that the policy rule may be triggered regardless of what metadata label is associated with the program counter.

In some embodiments, if the metadata label associated with the instruction to be executed matches the one or more transition metadata symbols indicated in the “code . . . ” portion of the policy rule, and the metadata label associated with the program counter matches the one or more state metadata symbols indicated in the “env== . . . ” portion of the policy rule, then the tag processing hardware 140 may allow execution of the instruction.

In some embodiments, the “env= . . . ” portion of the policy rule (after the right arrow) may indicate one or more state metadata symbols (e.g., “NS_Green, EW_Red”). At run time, if the tag processing hardware 140 determines that the instruction should be allowed, the tag processing hardware may update the metadata label associated with the program counter with the one or more state metadata symbols indicated in the “env= . . . ” portion of the policy rule. In this manner, the metadata label associated with the program counter may be used by the tag processing hardware 140 to keep track of state of the FSM 300 while the tag processing hardware 140 executes the FSM 300 at run time, alongside the application code of the traffic light controller.

The policy rules in the above example may be described as follows.
1. The first policy rule may represent the north-south lights turning green from a state in which all lights are red, resulting in a state in which the north-south lights are green, and the east-west lights are red.
2. The second policy rule may represent the east-west lights turning green from the state in which all lights are red, resulting in a state in which the north-south lights are red, and the east-west lights are green.
3. The third policy rule may represent the north-south lights turning yellow from the state in which the north-south lights are green, and the east-west lights are red, resulting in a state in which the north-south lights are yellow, and the east-west lights are red.
4. The fourth policy rule may represent the east-west lights turning yellow from the state in which the north-south lights are red, and the east-west lights are green, resulting in a state in which the north-south lights are red, and the east-west lights are yellow.
5. The fifth policy rule may represent the north-south lights turning red from the state in which the north-south lights are yellow, and the east-west lights are red, resulting in the state in which all lights are red.
6. The sixth policy rule may represent the east-west lights turning red from the state in which the north-south lights are red, and the east-west lights are yellow, resulting in the state in which all lights are red.
7. The seventh policy rule may indicate that all instructions not labeled with any of the transition metadata symbols (i.e., GoGreenNS, GoGreenEW, GoYellowNS, GoYellowEW, GoRedNS, and GoRedEW) may be allowed to execute, and may not cause any state change. This may correspond to a self-transition at each state, usually depicted as an arrow looping back to the same state, implicit in the illustrative FSM 300 shown in FIG. 3.

The inventors have recognized and appreciated that a state machine that represents desired behavior of an application may be simpler than full implementation code, and therefore may be easier to verify. In some embodiments, formal methods tools may be used to prove various properties of state machines, such as safety properties, spatial properties (e.g., information flow), temporal properties (e.g., execution ordering), etc. However, it should be appreciated that aspects of the present disclosure are not limited to checking any particular property of a state machine, or to using any state machine at all.

As described above in connection with the example of FIG. 1, the illustrative tag processing hardware 140 may send a query to the illustrative policy processor 150 to check if an instruction executed by the illustrative host processor 110 should be allowed. The query may include one or more inputs, such as an instruction type (e.g., opcode) of the instruction, a metadata tag for a program counter, a metadata tag for an application memory address from which the instruction is fetched (e.g., a word in memory to which the program counter points), a metadata tag for a register in which an operand of the instruction is stored, and/or a metadata tag for an application memory address referenced by the instruction.

In some embodiments, the policy processor 150 may have loaded therein one or more policies that describe allowed operations of the host processor 110, such as the illustrative signalSafety policy in the example of FIG. 3. In response to a query from the tag processing hardware 140, the policy processor 150 may evaluate one or more of the policies based on one or more inputs in the query from the tag processing hardware 140, to determine if an instruction in question should be allowed. If the instruction is not to be allowed, the policy processor 150 may so notify the tag processing hardware 140. If the instruction is to be allowed, the policy processor 150 may compute one or more outputs to be returned to the tag processing hardware 140. Additionally, or alternatively, the policy processor 150 may store the one or more inputs and/or the one or more corresponding outputs in the illustrative rule cache 144 for future reference.

It should be appreciated that an entry in the rule cache 144 may be different from a policy rule in a policy. Indeed, a single policy rule may sometimes induce multiple entries in the rule cache 144. For instance, with reference to the signalSafety policy, the policy rule

| rule_self (code == [-GoGreenNS, -GoGreenEW, | |
|---|---|
| | -GoYellowNS, -GoYellowEW, |
| | -GoRedNS, -GoRedEW], env == _ -> |

env = env)

may induce the following rule cache entries (assuming no other policy is concurrently enforced), where each entry may correspond to a self-transition at a respective state in the illustrative FSM 300 in the example of FIG. 3.

| | |
|---|---|
| <{}, | {NS_Red, EW_Red}, {NS_Red, EW_Red}> |
| <{}, | {NS_Green, EW_Red}, {NS_Green, EW_Red}> |
| <{}, | {NS_Yellow, EW_Red}, {NS_Yellow, EW_Red}> |
| <{}, | {NS_Red, EW_Green}, {NS_Red, EW_Green}> |
| <{}, | {NS_Red, EW_Green}, {NS_Red, EW_Green}> |

In this example, there are three slots in each rule cache entry. The first slot may be designated for the input code, the second slot may be designated for the input env, and the third slot may be designated for the output env. However, it should be appreciated that aspects of the present disclosure are not limited to having any particular number of input slot(s), or at all. Likewise, aspects of the present disclosure are not limited to having any particular number of output slot(s), or at all.

Policy rules in a policy may sometimes be referred to herein as “symbolic” rules. A symbolic rule may be instantiated with different combinations of metadata labels to obtain different “concrete” rules. For example, the policy rule rule_self above may be instantiated in five different ways to obtain five concrete rules corresponding, respectively, to the five rule cache entries above. Thus, rule cache entries may be examples of concrete rules.

The inventors have recognized and appreciated that the policy processor 150 may, in some instances, execute hundreds (or even thousands) of instructions to evaluate one or more policies on just one instruction executed by the host processor 110. Accordingly, in some embodiments, the host processor 110 may be stalled to allow the policy processor 150 to catch up. However, this may create a delay that may be undesirable for some real time applications. For example, the host processor 110 may be on an electric vehicle, and may control circuit switching that takes place thousands of times per second to keep an electric motor running smoothly. Such time sensitive control operations may be disrupted if the host processor 110 is stalled waiting for policy evaluation to be completed.

The inventors have further recognized and appreciated that, although the rule cache 144 may be used to speed up accesses to concrete rules, such a speedup may be available only after a concrete rule has already been computed by the policy processor 150 and installed into the rule cache 144. When the tag processing hardware 140 queries the rule cache 144 with a certain list of one or more inputs for the first time, the rule cache 144 may indicate there is a cache miss, and the tag processing hardware 140 may request that the policy processor 150 perform policy evaluation on the one or more inputs, which may cause an undesirable delay.

Accordingly, in some embodiments, one or more concrete rules may be computed and installed into a rule cache before run time. For instance, the illustrative policy compiler 220 in the example of FIG. 2 may be programmed to compute one or more concrete rules at compile time. Additionally, or alternatively, the illustrative policy linker 225 may be programmed to compute one or more concrete rules at link time. The illustrative loader 215 may resolve metadata labels in the one or more concrete rules computed by the policy compiler 220 and/or the policy linker 225 into binary representations, and may load the one or more concrete rules (with binary representations substituted for the respective metadata labels) into the rule cache 144. In this manner, the one or more concrete rules may be made available at run time without invoking the policy processor 150.

However, the inventor has recognized and appreciated a number of challenges in computing and installing concrete rules before run time. For instance, the inventor has recognized and appreciated that a number of possible metadata labels may grow exponentially with a number of distinct metadata symbols. With reference to the illustrative signalsafety policy in the example of FIG. 3, there may be 12 distinct metadata symbols, including six state metadata symbols (i.e., NS_Green, EW_Green, NS_Yellow, EW_Yellow, NS_Red, and EW_Red) and six transition metadata symbols (i.e., GoGreenNS, GoGreenEW, GoYellowNS, GoYellowEW, GoRedNS, and GoRedEW). Thus, 2\hat{ }\12=4096 different metadata labels may be generated, each label corresponding to a different subset of the 12 metadata symbols.¹ ¹ The same analysis may apply to a composite policy where the component policies collectively use 12 distinct metadata symbols.

Moreover, since each symbolic rule in the signalsafety policy may have two inputs (e.g., code and env), a total of 4096\hat{ }2=16,777,216 different input patterns may be possible. For a similar policy with three inputs (e.g., code and env, along with mem, a metadata label associated with an application memory location referenced by the instruction being checked), a total of 4096\hat{ }3=68,719,476,736 different input patterns may be possible. It may not be practical to evaluate each of these input patterns to determine if the input pattern leads to a concrete rule that should be installed into the rule cache 144.

Accordingly, in some embodiments, techniques are provided for identifying input patterns that may correspond to concrete rules to be installed into a rule cache. For instance, a policy language may be provided with one or more features that may be used (e.g., by the policy compiler 220) to identify certain input patterns for which concrete rules may be computed ahead of time, and/or certain input patterns for which concrete rules may not be computed ahead of time.

The inventors have recognized and appreciated that, for a concrete rule that is computed ahead of time, run time performance may be improved because the tag processing hardware 140 may be able to retrieve that concrete rule from the rule cache 144 without invoking the policy processor 150. On the other hand, for a concrete rule that is not computed ahead of time, the tag processing hardware 140 may experience a miss at the rule cache 144, and may, in response, simply query the policy processor 150. Thus, run time performance may be no worse than that observed in an implementation where no pre-computation is performed.

In sum, computing and installing concrete rules before run time may improve run time performance in some cases, without imposing any penalty in other cases. Moreover, because a concrete rule may be computed in the same way regardless of when the computation takes place (e.g., either before or at run time), there may be no negative impact to security, safety, or any other property of concern.

In some embodiments, a policy language may be provided that allows a policy author to declare a new metadata type T as a sum of a plurality of other metadata types S₀, S₁, . . . .

T=Sum(S₀,S₁, . . . )

With reference to the illustrative signalSafety policy, a new sum type NS_T may be declared as follows.

| data (Data) NS_T<fixed> = NS_Red | |
|---|---|
| | \| NS_Yellow |
| | \| NS_Green |

In some embodiments, the policy compiler 220 and/or the policy linker 225 may be programmed to generate possible metadata labels for the type NS_T as follows.

{ },{NS_Green},{NS_Yellow},{NS_Red}

Thus, a metadata label of the type NS_T may include either no metadata symbol, or exactly one of the metadata symbols NS_Green, NS_Yellow, and NS_Red. Subsets with multiple elements (i.e., {NS_Green, NS_Yellow}, {NS_Yellow, NS_Red}, {NS_Green, NS_Red} and {NS_Red, NS_Yellow, NS_Green}) may be excluded. This semantics may be suitable for the signalSafety policy because it may be assumed that a traffic light may not show multiple colors simultaneously.

The inventors have recognized and appreciated that, with the above described semantics, a number of possible metadata labels for a sum type T=Sum (S₀, S₁, . . . , S_{N}), where each Sᵢ includes a distinct metadata symbol, may grow linearly with N, as opposed to exponentially with N. This may in turn reduce a number of concrete rules to be computed and installed ahead of time.

In some embodiments, a policy language may be provided that allows a policy author to assign a domain to a metadata type T. With reference to the above example, the metadata type NS_T may be assigned a domain Data.

Additionally, or alternatively, a new metadata type EW_T may be declared as follows, with the Data domain.

| data (Data) EW_T<fixed> = EW_Red | |
|---|---|
| | \| EW_Yellow |
| | \| EW_Green |

Additionally, or alternatively, a new metadata type Transition_T may be declared as follows, with a domain Instruction.

| data (Instruction) Transition_T<fixed> = GoGreenNS | |
|---|---|
| | \| GoGreenEW |
| | \| GoRedNS |
| | \| GoRedEW |
| | \| GoYellowNS |
| | \| GoYellowEW |

In some embodiments, the policy compiler 220 and/or the policy linker 225 may be programmed to generate possible metadata labels such that no metadata symbol assigned the Data domain may appear in a same metadata label as a metadata symbol assigned the Instruction domain. Thus, a subset such as {NS_Green, EW_Yellow} may be included, but a subset such as {NS_Green, GoYellowNS} may be excluded. This semantics may be suitable for the signalSafety policy because transition metadata symbols may be used to label instructions but not state variables, whereas state metadata symbols may be used to label state variables but not instructions.

The inventors have recognized and appreciated that, with both the illustrative sum type feature and the illustrative domain feature described above, only 6*9=54 different metadata labels may be generated (6 possibilities for the Instruction domain and 3*3=9 possibilities for the Data domain), as opposed to 4096 different metadata labels. For a policy with two inputs, a total of 54\hat{ }2=2,916 different input patterns may be possible, which is a significant reduction from 4096\hat{ }2=16,777,216 different input patterns. Likewise, for a policy with three inputs, a total of 54\hat{ }3=157,464 different input patterns may be possible, which is a significant reduction from 4096\hat{ }3=68,719,476,736 different input patterns. However, it should be appreciated that aspects of the present disclosure are not limited to using a policy language with a sum type feature or a domain feature, or any policy language at all.

The inventors have further recognized and appreciated that, in some instances, it may be known ahead of time that a certain input may only be associated with metadata labels from a certain domain. With reference to the signalSafety policy, the code input may be associated with the Instruction domain, whereas the env input may be associated with the Data domain.

// Field declarations
field env : Data
field code : Instruction

Thus, only 6*9=54 different input patterns may be possible (6 possibilities for code and 3*3=9 possibilities for env), which is a further reduction from 2,916 different input patterns. Even with three inputs, one associated with the Instruction domain and two associated with the Data domain, only 6*9*9=486 different input patterns may be possible, which is a further reduction from 157,464 different input patterns.

The inventors have further recognized and appreciated that, in some instances, run time performance may not be of concern for instructions to be disallowed. For example, in response to determining that an instruction is to be disallowed (e.g., based on a miss in the rule cache 144, followed by a response from the policy processor 150 indicating a policy violation has been found), the tag processing hardware 140 may send an interrupt to the host processor 110, which may cause the host processor 110 to switch to suitable violation processing code. A delay caused by such a context switch and/or the violation processing code itself may be large relative to a delay caused by invoking the policy processor 150 to check the instruction.

By contrast, run time performance may be of significant concern for instructions to be allowed. For instance, in the electric motor example described above, the host processor 110 may be responsible for controlling circuit switching thousands of times per second. All of the instructions associated with such control operations may be allowed instructions. Thus, it may be desirable to check allowed instructions in an efficient manner.

Accordingly, in some embodiments, the policy compiler 220 and/or the policy linker 225 may be programmed to generate input patterns corresponding to instructions to be allowed. Additionally, or alternatively, the policy compiler 220 and/or the policy linker 225 may evaluate such input patterns to obtain corresponding output patterns. Resulting concrete rules may be installed into the rule cache 144 for efficient access at run time.

The inventors have recognized and appreciated that input patterns corresponding to instructions to be allowed may be a small fraction of all possible input patterns. As such, it may be computationally feasible to evaluate all input patterns corresponding to instructions to be allowed, and to install resulting concrete rules into the rule cache 144.

With reference to the signalSafety policy, assuming both the illustrative sum type feature and the illustrative domain feature are used, and no other policy is enforced concurrently, each of the first 6 policy rules may be matched by exactly one input pattern. For instance, with respect to the policy rule “rule_1,” the policy compiler 220 and/or the policy linker 225 may determine that only one metadata label (i.e., {GoGreenNS}) may match “code==[+GoGreenNS],” and only one metadata label (i.e., {NS_Red, EW_Red}) may match “env==[NS_Red, EW_Red].”

Similarly, assuming that both the illustrative sum type feature and the illustrative domain feature are used, and that no other policy is enforced concurrently, the last policy rule may be matched by 9 input patterns. For instance, with respect to the policy rule “rule_self,” the policy compiler 220 and/or the policy linker 225 may determine that only one metadata label (i.e., the empty label { }) may match “code [−GoGreenNS, −GoGreenEW, −GoYellowNS, −GoYellowEW, −GoRedNS, −GoRedEW],” and 3*3=9 metadata labels (3 possibilities from NS_T and 3 possibilities from EW_T) may match the wildcard for env.

Thus, only 6+9=15 input patterns may correspond to instructions to be allowed, which may be a small fraction of all 54 possible input patterns.

In some embodiments, the policy compiler 220 and/or the policy linker 225 may use a Boolean satisfiability solver to identify input patterns. For instance, a Boolean satisfiability solver may be used to identify one or more input patterns that trigger at least one symbolic rule in a policy. Any suitable Boolean satisfiability solver may be used, including, but not limited to, a satisfiability modulo theories (SMT) solver.

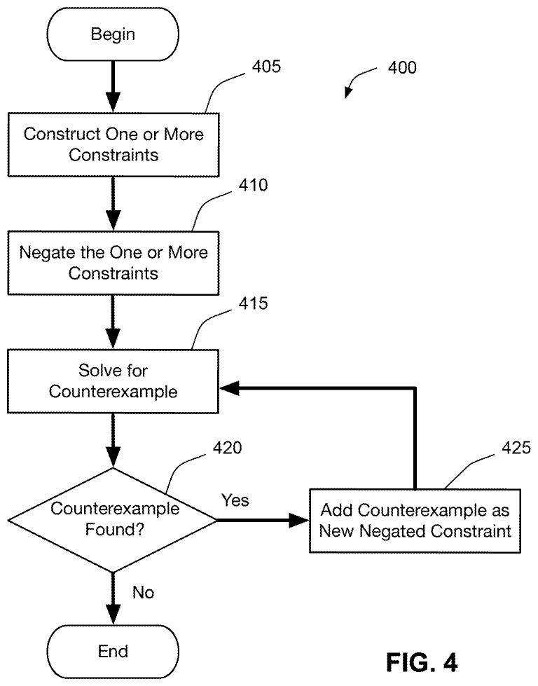

FIG. 4 shows an illustrative process 400 that may be used to identify one or more input patterns, in accordance with some embodiments. For instance, the process 400 may be used to identify one or more input patterns that each trigger at least one symbolic rule in the illustrative signalSafety policy described in connection with the example of FIG. 3.

At act 405, one or more constraints may be constructed based on a symbolic rule. In some embodiments, a constraint may be a condition having one or more Boolean variables corresponding, respectively, to one or more metadata symbols appearing in the symbolic rule. As an example, a plus “+” construct in the policy language may be translated into a Boolean equation. For instance, “code==[+GoGreenNS]” may be translated into a constraint code_GoGreenN=1 for the input code. In some embodiments, the “plus” construct may be inferred, so that “code==[GoGreenNS]” may also be translated into a constraint code_GoGreenN=1 for the input code.

As another example, a minus “−” construct in the policy language may be translated into a Boolean equation. For instance, “code==[−GoGreenNS]” may be translated into a constraint code_GoGreenN=0 for the input code.

In some embodiments, a list of one or more plus “+” constructs and/or minus “−” constructs may be translated into a conjunction. For instance, “code==[−GoGreenNS, −GoGreenEW, −GoYellowNS, −GoYellowEW, −GoRedNS, −GoRedEW]” may be translated into a constraint for the input code as follows.

code_GoGreenN=0 and code_GoGreenEW=0 and code_GoYellowNS=0 and
code_GoYellowEW=0 and code_GoRedNS=0 and code_GoRedEW=0

In some embodiments, a list of one or more metadata symbols may be translated into a conjunction. For instance, “env==[NS_Red, EW_Red]” may be translated into a constraint for the input env as follows.

env_NS_Red=1 and env_EW_Red=1

In some embodiments, two constraints constructed based on a same symbolic rule, but for different inputs, may be combined via a conjunction. Consider, for example, the policy rule “rule_1” in the signalSafety policy.

rule_1(code == [+GoGreenNS], env == [NS_Red, EW_Red] ->
env = {NS_Green, EW_Red})

The two conditions in this rule, “code==[+GoGreenNS]” and “env==[NS_Red, EW_Red],” may be translated into the following conjunction, with prefixes “code” and “env” differentiating Boolean variables corresponding to the input code and the input env, respectively.

Illustrative Constraint (1)

(code_GoGreenNS=1 )and
(env_NS_Red=1 and env_EW_Red=1 )

In some embodiments, a constraint may be constructed based on a sum type. For instance, a constraint based on the sum type NS_T may be expressed in disjunctive normal form as follows.

(NS_Red=1 and NS_Yellow=0 and NS_Green=0) or
(NS_Red=0 and NS_Yellow=1 and NS_Green=0) or
(NS_Red=0 and NS_Yellow=0 and NS_Green=1) or
(NS_Red=0 and NS_Yellow=0 and NS_Green=0)

Additionally, or alternatively, a constraint based on the sum type NS_T may be expressed in conjunctive normal form as follows.

(NSRed or NS_Yellow=0) and
(NS_Red=0 or NS_Green=0) and
(NS_Yellow=0 or NS_Green=-)

However, it should be appreciated that aspects of the present disclosure are not limited to using disjunctive normal form or conjunctive normal form, or any particular logical form. In some embodiments, an equivalent formula may be used, such as the following.

not (NS_Red=1 and NS_Yellow=1) and
not (NS_Red=1 and NS_Green=l) and
not (NS_Yellow=1 and NS_Green=1)

In some embodiments, a constraint may be constructed based on the sum type EW_T, and may be similar to any one of the illustrative constraints described above in connection with the sum type NS_T. Since the input env may be associated with the sum types Ns_T and EW_T via the Data domain, both a constraint for the sum type Ns_T and a constraint for the sum type EW_T may be provided for the input env, for example, as follows.

Illustrative Constraint (2)

```
( (env_NS_Red=1 and env_NS_Yellow=0 and env_NS_Green=0) or
  (env_NS_Red=0 and env_NS_Yellow=1 and env_NS_Green=0) or
  (env_NS_Red=0 and env_NS_Yellow=0 and env_NS_Green=1) or
  (env_NS_Red=0 and env_NS_Yellow=0 and env_NS_Green=0)) and
( (env_EW_Red=1 and env_EW_Yellow=0 and env_EW_Green=0) or
  (env_EW_Red=0 and env_EW_Yellow=1 and env_EW_Green=0) or
  (env_EW_Red=0 and env_EW_Yellow=0 and env_EW_Green=1) or
  (env_EW_Red=0 and env_EW_Yellow=0 and env_EW_Green=0) )
```

In some embodiments, a constraint may be constructed based on the sum type Transition_T, and may be similar to any one of the illustrative constraints described above in connection with the sum type Ns_T (albeit with six, instead of three, variables). Since the input code may be associated with the type Transition_T via the Instruction domain, a constraint for the sum type Transition_T may be provided for the input code, for example, as follows.

Illustrative Constraint (3)

```
  (code_GoRedNS=l and code_GoYellowNS=0 and code_GoGreenNS=0 and
code_GoRedEW=0 and code_GoYellowEW=0 and code_GoGreenEW=0) or
  (code_GoRedNS=0 and code_GoYellowNS=l and code_GoGreenNS=0 and
code_GoRedEW=0 and code_GoYellowEW=0 and code_GoGreenEW=0) or
  (code_GoRedNS=0 and code_GoYellowNS=0 and code_GoGreenNS=1 and
code_GoRedEW=0 and code_GoYellowEW=0 and code_GoGreenEW=0) or
  (code_GoRedNS=0 and code_GoYellowNS=0 and code_GoGreenNS=0 and
code_GoRedEW=l and code_GoYellowEW=0 and code_GoGreenEW=0) or
  (code_GoRedNS=0 and code_GoYellowNS=0 and code_GoGreenNS=0 and
code_GoRedEW=0 and code_GoYellowEW=l and code_GoGreenEW=0) or
  (code_GoRedNS=0 and code_GoYellowNS=0 and code_GoGreenNS=0 and
code_GoRedEW=0 and code_GoYellowEW=0 and code_GoGreenEW=1) or
  (code_GoRedNS=0 and code_GoYellowNS=0 and code_GoGreenNS=0 and
code_GoRedEW=0 and code_GoYellowEW=0 and code_GoGreenEW=0)
```

In some embodiments, a constraint may be constructed based on a domain. As an example, the state metadata symbols NS_Red, NS_Yellow, NS_Green, EW_Red, EW_Yellow, and EW_Green may be associated with the Data domain (via the types NS_T and EW_T). The following constraint may be constructed for the Data domain: p₀=0 and . . . and p_{N-1}=0, where p₀, . . . , p_{N-1} are all metadata symbols not associated with the Data domain (e.g., the transition metadata symbols GoRedNS, GoYellowNS, GoGreenNS, GoRedEW, GoYellowEW, and GoGreenEW, and/or one or more metadata symbols of one or more other domains).

As another example, the transition metadata symbols GoRedNS, GoYellowNS, GoGreenNS, GoRedEW, GoYellowEW, and GoGreenEW may be associated with the Instruction domain (via the type Transition_T). The following constraint may be constructed for the Instruction domain: q₀=0 and . . . and g_{M-1}=0, where q₀, . . . , g_{M-1} are all metadata symbols not associated with the Instruction domain (e.g., the state metadata symbols NS_Red, NS_Yellow, NS_Green, EW_Red, EW_Yellow, and EW_Green, and/or one or more metadata symbols of one or more other domains).

In some embodiments, because the input env may be associated with the Data domain, a constraint based on the Data domain may be provided for the input env, for example, as follows.

Illustrative Constraint (4)

env_GoRedNS=0 and env_GoYellowNS=0 and env_GoGreenNS=0 and
env_GoRedEW=0 and env_GoYellowEW=0 and env_GoGreenEW=0

Additionally, or alternatively, because the input code may be associated with the instruction domain, a constraint based on the Instruction domain may be provided for the input code, for example, as follows.

Illustrative Constraint (5)

codeNS_Red=O and code_NS_Yellow=0 and code_NS_Green=0 and
code_EW_Red=0 and code_EW_Yellow=0 and code_EW_Green=0

Returning to act 405 in the example of FIG. 4, one or more constraints R₀, R₁, . . . may be provided using any one or more of the illustrative techniques described above. For example, the one or more constraints R₀, R₁, . . . may include one or more of the illustrative constraints (1)-(5). The inventors have recognized and appreciated that the following formula may be logically equivalent to a negation of a conjunction of the one or more constraints R₀, R₁, . . . .

(not R₀) or (not R₁) or . . . .

Thus, a counterexample to the above logical formula (i.e., an assignment of truth values to the Boolean variables that makes the above logical formula false) may provide an assignment of truth values to the Boolean variables that satisfies all of the constraints R₀, R₁, . . . .

Accordingly, at act 410 in the example of FIG. 4, the one or more constraints R₀, R₁, . . . may be negated, thereby obtaining (not R₀) (not R₁), . . . . Then, at act 415, a Boolean satisfiability solver may be used to solve for a counterexample to (not R₀) or (not R₁) or . . . .

The inventors have further recognized and appreciated that an assignment of truth values to the Boolean variables that satisfies all of the constraints R₀, R₁, . . . may correspond to an input pattern that may trigger the policy rule “rule_1” in the signalSafety policy.

Accordingly, if it is determined at act 420 that a counterexample c to (not R₀) or (not R₁) or . . . is found, an input pattern determined from such a counterexample may be recorded for the policy rule “rule_1” in the signalSafety policy. Additionally, or alternatively, c may be added at act 425 as a new negated constraint, and the process 400 may return to act 415 to solve for a counterexample to the following formula.

(not R₀) or (not R₁) or . . . or C

In this manner, any new counterexample identified may satisfy all of the constraints R₀, R₁, . . . , but may be different from the counterexample c. This may be repeated until no new counterexample is identified, which may result in a set of one or more input patterns, where each input pattern may trigger the policy rule “rule_1” in the signalSafety policy. In some embodiments, the process 400 may be performed for each symbolic rule in the signalSafety policy to obtain a respective set of one or more input patterns. An input pattern in any of such sets may be installed into the rule cache 144 for efficient access at run time.

It should be appreciated that aspects of the present disclosure are not limited to identifying input patterns in any particular manner. For instance, in some embodiments, the one or more constraints R₀, R₁, . . . may be combined via a conjunction, which may in turn be converted into disjunctive normal form. The inventors have recognized and appreciated that each disjunct in a logical formula in disjunctive normal form may correspond to a partial assignment of truth values, and one or more full assignments may be constructed that are consistent with the partial assignment (e.g., by assigning 0 or 1 to each Boolean variable not appearing in the disjunct). The one or more full assignments may then be used to obtain one or more input patterns be installed into the rule cache 144 for efficient access at run time.

As discussed above, run time performance may, in some instances, not be of concern for instructions to be disallowed. Accordingly, in some embodiments, input patterns corresponding to instructions to be disallowed may not be computed ahead of time. Instead, such input patterns may be evaluated at run time (e.g., by invoking the illustrative policy processor 150 in the example of FIG. 1). However, it should be appreciated that aspects of the present disclosure are not so limited. In some embodiments, a symbolic rule may be provided that may be matched by an input pattern corresponding to one or more instructions to be disallowed. Such a rule may map the input pattern to an error message that may be used for debugging and/or run time diagnostic purposes.

As an example, the illustrative signalSafety policy may, in some embodiments, include one or more policy rules corresponding to disallowed transitions of the FSM 300 in the example of FIG. 3, in addition to, or instead of, one or more policy rules corresponding to allowed transitions of the FSM 300. For instance, one or more of the following policy rules may be included, in addition to, or instead of, one or more of the seven illustrative policy rules above.

...
\hat{ } rule_8 (code == [+GoGreenNS] , env == [+EW_Green] ->
fail “Safety Violation - East-West Lights Still Green”)
\hat{ } rule_9(code == [+GoGreenNS], env == [+EW_Yellow] ->
fail “Safety Violation - East-West Lights Still Yellow”)
\hat{ } rule_10(code == [+GoYellowNS], env == [+EW_Green] ->
fail “Safety Violation - East-West Lights Still Green”)
\hat{ } rule_11(code == [+GoYellowNS], env == [+EW_Yellow] ->
fail “Safety Violation - East-West Lights Still Yellow”)
\hat{ } rule_12(code == [+GoGreenEW], env == [+NS_Green] ->
fail “Safety Violation - North-South Lights Still Green”)
\hat{ } rule_13(code == [+GoGreenEW], env == [+NS_Yellow] ->
fail “Safety Violation - North-South Lights Still Yellow”)
\hat{ } rule_14(code == [+GoYellowEW], env == [+NS_Green] ->
fail “Safety Violation - North-South Lights Still Green”)
\hat{ } rule_15(code == [+GoYellowEW], env == [+NS_Yellow] ->
fail “Safety Violation - North-South Lights Still Yellow”)
\hat{ } rule_16(code == _ , env == [NS_Yellow, EW_Green] ->
fail “Safety Violation - Neither Set of Lights Is Red”)
\hat{ } rule_17(code == _, env == [NS_Green, EW_Yellow] ->
fail “Safety Violation - Neither Set of Lights Is Red”)
\hat{ } rule_18(code == _, env == [NS_Green, EW_Green] ->
fail “Safety Violation - Neither Set of Lights Is Red”)
\hat{ } rule_19(code == _, env == [NS_Yellow, EW_Yellow] ->
fail “Safety Violation - Neither Set of Lights Is Red”)

The additional policy rules may be described as follows.
8. The eighth policy rule may indicate that the north-south lights turning green from any state in which the east-west lights are green is a violation of the safety policy.
9. The ninth policy rule may indicate that the north-south lights turning green from any state in which the east-west lights are yellow is a violation of the safety policy.
10. The tenth policy rule may indicate that the north-south lights turning yellow from any state in which the east-west lights are green is a violation of the safety policy.
11. The eleventh policy rule may indicate that the north-south lights turning yellow from any state in which the east-west lights are yellow is a violation of the safety policy.
12. The twelfth policy rule may indicate that the east-west lights turning green from any state in which the north-south lights are green is a violation of the safety policy.
13. The thirteenth policy rule may indicate that the east-west lights turning green from any state in which the north-south lights are yellow is a violation of the safety policy.
14. The fourteenth policy rule may indicate that the east-west lights turning yellow from any state in which the north-south lights are green is a violation of the safety policy.
15. The fifteenth policy rule may indicate that the east-west lights turning yellow from any state in which the north-south lights are yellow is a violation of the safety policy.
16. The sixteenth policy rule may indicate that all instructions executing at a time when the north-south lights are yellow, and the east-west lights are green, is a violation of the safety policy.
17. The seventeenth policy rule may indicate that all instructions executing at a time when the north-south lights are green, and the east-west lights are yellow, is a violation of the safety policy.
18. The eighteenth policy rule may indicate that all instructions executing at a time when both the north-south lights and the east-west lights are green is a violation of the safety policy.
19. The nineteenth policy rule may indicate that all instructions executing at a time when both the north-south lights and the east-west lights are yellow is a violation of the safety policy.

The inventors have recognized and appreciated that, in some instances, it may be advantageous to explicitly model a disallowed transition in an FSM via a policy rule. For instance, the tag processing hardware 140 may issue an appropriate error message (e.g., “East-West Lights Still Green”) when a policy rule corresponding to a disallowed transition is matched. In some embodiments, such an error message may be consumed by a debugging tool (e.g., the illustrative debugger 230 in the example of FIG. 2).

A disallowed transition that triggers a policy rule is sometimes referred to herein as an “explicitly” disallowed transition. A disallowed transition that does not trigger any policy rule is sometimes referred to herein as an “implicitly” disallowed transition.

In some embodiments, the illustrative process 400 in the example of FIG. 4 (or some other suitable process for identifying input patterns) may be performed for each of the above symbolic rules to obtain a respective set of one or more input patterns corresponding to explicitly disallowed transitions. An input pattern in any of such sets may be installed into the rule cache 144 for efficient access at run time, in addition to, or instead of, one or more input patterns corresponding to allowed transitions.

In some embodiments, the rule cache 144 may map one or more input patterns corresponding to disallowed transitions to a failure identifier. In response to the rule cache 144 mapping an input pattern for an instruction to the failure identifier, the tag processing hardware 140 may log a corresponding error message. If the tag processing hardware 140 is operating in a logging mode, the tag processing hardware 140 may allow the instruction despite the error message. Otherwise, the tag processing hardware 140 may trigger policy violation processing.

In some embodiments, a concrete rule may include one or more input metadata labels and/or one or more output metadata labels. For instance, with reference to the policy rule “rule_self” in the illustrative signalSafety policy in the example of FIG. 3, the following concrete rule may include a first input metadata label { } (the empty set) in the first slot, a second input metadata label {NS_Red, EW_Red} in the second slot, and an output metadata label {NS_Red, EW_Red} in the third slot.

In some embodiments, one or more metadata labels of a concrete rule may be resolved into one or more respective binary representations. Installing the concrete rule into the rule cache 144 may include using the one or more binary representations to create a rule cache entry. To check if an input pattern matches any concrete rule stored in the rule cache 144, one or more metadata labels in the input pattern may be used to perform a lookup in the rule cache 144. The one or more metadata labels may be retrieved from a metadata storage (e.g., the illustrative metadata memory 125 and/or the tag register file 146 in the example of FIG. 1), and may be represented by one or more respective binary representations.

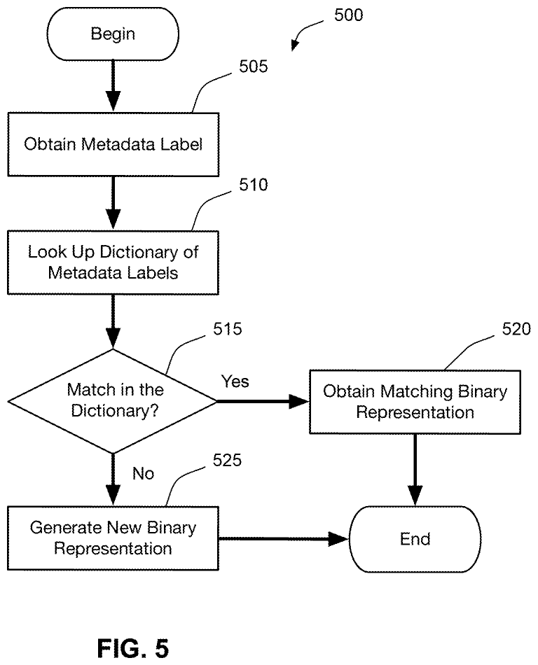

FIG. 5 shows an illustrative process 500 for resolving a metadata label into a binary representation, in accordance with some embodiments. The process 500 may be performed at any suitable time, such as compile time, link time, load time, and/or run time. For instance, part or all of the process 500 may be performed by the illustrative policy compiler 220, the illustrative policy linker 225, and/or the illustrative loader 215 in the example of FIG. 2. Additionally, or alternatively, the illustrative policy processor 150 may be programmed to perform part or all of the process 500 at run time.

At act 505, a metadata label may be obtained. For instance, a metadata label (e.g., represented by a list of one or more metadata symbols) may be received as input. Additionally, or alternatively, a list may be dynamically allocated to represent a metadata label. One or more metadata symbols may be added to the list incrementally, for example, as one or more policies are evaluated that reference the one or more metadata symbols.

In some embodiments, the list may be sorted according to a suitable ordering of metadata symbols, so that a same list may result regardless of an order in which the one or more metadata symbols are received and/or added. Below is an example of an ordering of metadata symbols for the illustrative signalSafety policy described in connection with the example of FIG. 3.

NS_Red, NS_Yellow, NS_Green, EW_Red, EW_Yellow, EW_Green,
GoRedNS, GoYellowNS, GoGreenNS, GoRedEW, GoYellowEW,
GoGreenEW

At act 510, the metadata label obtained at act 505 (e.g., the list of one or more metadata symbols) may be used to look up a dictionary that maps metadata labels to corresponding binary representations. For instance, at run time, such a dictionary may be maintained by the tag processing hardware 140 and/or the policy processor 150. Additionally, or alternatively, at compile time, link time, or load time, such a dictionary may be maintained by the policy compiler 220, the policy linker 225, or the loader 215, respectively.

In some embodiments, the dictionary may be implemented using a hash table. Thus, a suitable hash function may be applied to the list representing the metadata label, and a resulting hash may be used to look up the hash table.

At act 515, it may be determined whether the metadata label matches an entry in the dictionary. If it is determined that there is a match, a matching binary representation may be obtained at act 520. Otherwise, a new binary representation may be generated at act 525.

For instance, if the hash of the list representing the metadata label maps to a non-empty bucket in the hash table implementing the dictionary, the list may be compared against one or more entries in the bucket to determine if there is a match. If there is a match, a binary representation of the matching entry may be used. Otherwise, a new binary representation may be generated. For instance, a counter may be maintained that counts a number of binary representations that have been used so far. This counter may be incremented each time a new binary representation is requested, and a binary string representing a value of the counter may be used as the new binary representation.

In some embodiments, the binary representation generated at act 525 may be added to the dictionary, so that the binary representation will be available if the same metadata label is encountered again in the future.

It should be appreciated that aspects of the present disclosure are not limited to resolving a metadata label into a binary representation in any particular manner, or at all. For instance, in some embodiments, a dictionary may be implemented using a graph, in addition to, or instead of a hash table.

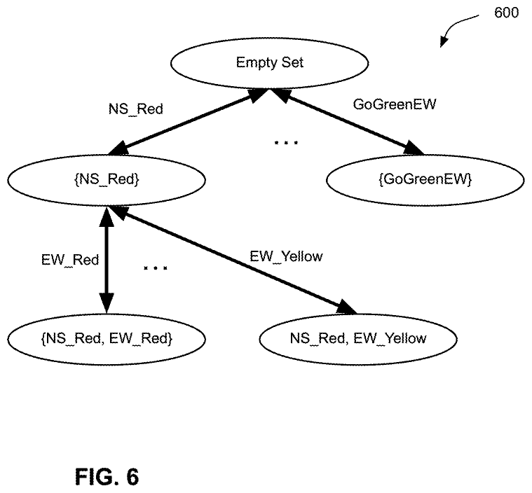

FIG. 6 shows an illustrative graph 600 that may be used to resolve a metadata label into a binary representation, in accordance with some embodiments. For instance, the graph 600 may be built ahead of time, and may be traversed when a binary representation is requested. However, it should be appreciated that the graph 600 may be built at any suitable time (e.g., compile time, link time, load time, and/or run time) Likewise, the graph 600 may be traversed at any suitable time (e.g., compile time, link time, load time, and/or run time).

In some embodiments, the graph 600 may include all possible metadata labels (e.g., as determined using one or more of the illustrative techniques described herein, such as sum type, domain, etc.). In this manner, a match may always be found at act 515 of the illustrative process 500 in the example of FIG. 5, so that a matching binary representation may simply be obtained at act 520, as opposed to generating a new binary representation at act 525, which may involve more computation (e.g., hashing). This may advantageously reduce delay and/or power consumption when a binary representation is requested.

However, the inventor has recognized and appreciated that, if the graph 600 includes all possible metadata labels, more memory may be used to store the graph 600. Accordingly, in some embodiments, the graph 600 may not include all possible metadata labels initially. As metadata labels are encountered, corresponding binary representations may be added to the graph 600.

In some embodiments, a node in the graph 600 may correspond to a set of metadata symbols. For instance, there may be a node corresponding to the empty set. Additionally, or alternatively, there may be one or more nodes corresponding, respectively, to one or more non-empty sets of metadata symbols (e.g., {NS_Red}, {GoGreenEW}, {NS_Red, EW_Red}, {NS_Red, EW_Yellow}, etc. in the example of FIG. 6). Such a node may store a binary representation of the corresponding set of metadata symbols.

In some embodiments, given a node corresponding to a set S of metadata symbols, there may be an edge labeled with a metadata symbol A (e.g., EW_Red) not already in the set S (e.g., {Ns_Red}). Such an edge may lead to a target node corresponding to a set S′ (e.g., {NS_Red, EW_Red}), which may be a result of adding the metadata symbol A to the set S. Additionally, or alternatively, there may be an edge labeled with a metadata symbol B (e.g., NS_Red) that is in the set S (e.g., {Ns_Red}), where the edge may lead to a target node corresponding to a set S″ (e.g., the empty set), which may be a result of removing the metadata symbol B from the set S. In the example of FIG. 6, a pair of edges going in opposite directions between the same pair of nodes is shown as a double-headed arrow. However, it should be appreciated that aspects of the present disclosure are not limited to having edges in both directions between a pair of nodes.

In some embodiments, the graph 600 may be traversed from the node corresponding to the empty set. For example, one or more metadata symbols may be incrementally added to reach a node with a desired binary representation. Additionally, or alternatively, starting from a node corresponding to a non-empty set of metadata symbols, one or more metadata symbols may be incrementally added and/or removed to reach a node with a desired binary representation.

The inventors have recognized and appreciated that, in some instances, a metadata label may only be used as an intermediate label when generating one or more other metadata labels. For instance, a metadata label {C} may only be used in generating metadata labels {A, C} and {B, C}. The metadata label {C} itself may not appear in any concrete rule to be installed into a rule cache. Accordingly, in some embodiments, no binary representation may be generated for such a metadata label, which may reduce an amount of memory used to store binary representations of metadata labels. For instance, a set of concrete rules to be installed may be determined in a suitable manner (e.g., using the illustrative process 400 in the example of FIG. 4 to identify input patterns), so that binary representations may be generated for those metadata labels that appear in at least one concrete rule to be installed.

The inventors have further recognized and appreciated that obtaining a binary representation at run time or load time by hashing or graph traversal may cause an undesirable delay. Moreover, hashing may consume additional processor cycles (and hence power), while storing a graph of binary representations may consume additional memory. Accordingly, in some embodiments, the illustrative policy compiler 220 and/or the illustrative policy linker 225 in the example of FIG. 2 may resolve one or more metadata labels in a concrete rule into one or more respective binary representations. The concrete rule may be provided in binary form (e.g., with the one or more respective binary representations substituted for the one or more metadata labels) to the illustrative loader 215, for instance, as part of an initialization specification. The loader 215 may load the concrete rule in binary form into the illustrative rule cache 144 in the example of FIG. 1. In this manner, computation may be shifted from run time and/or load time to compile time and/or link time, which may improve performance and/or reduce memory overhead for run time and/or load time.

As discussed above in connection with the example of FIG. 1, the rule cache 144 may be implemented using a hash function and a selected memory, such as an on-chip random access memory (RAM). For instance, a rule cache entry may include an input pattern in binary form (e.g., with one or more respective binary representations substituted for one or more input metadata labels). Additionally, or alternatively, the rule cache entry may include an output pattern in binary form (e.g., with one or more respective binary representations substituted for one or more output metadata labels). A hash function may be applied to the input pattern in binary form to generate an address in the selected memory. The rule cache entry may be stored at that address in the selected memory.

The inventors have recognized and appreciated that a rule cache collision may occur in such an implementation. For instance, a rule cache entry having a first input pattern may be installed into the rule cache 144. Subsequently, the rule cache 144 may be queried with a second input pattern, which may be different from the first input pattern, but may hash to a same address. The rule cache 144 may retrieve the rule cache entry from the selected memory, only to determine that the second input pattern does not match the first input pattern stored in the retrieved rule cache entry. Thus, the retrieved rule cache entry may be inapplicable, and the illustrative policy processor 150 in the example of FIG. 1 may be queried with the second input pattern.

The inventors have recognized and appreciated that rule cache collisions may result in a performance degradation, especially if multiple collisions happen in close succession. For example, two concrete rules that are triggered frequently may happen to have input patterns that hash to a same address. This may cause cache thrashing, where the two rules may alternately cause each other to be evicted from the rule cache 144, even if other addresses in the rule cache 144 may still be available to store concrete rules.

Accordingly, in some embodiments, techniques are provided for avoiding (e.g., making less frequent or even eliminating) rule cache collisions. For instance, metadata labels may be resolved into binary representations in an adaptive manner, whereby one or more binary representations that would cause a collision may be replaced by one or more binary representations that would not cause a collision.

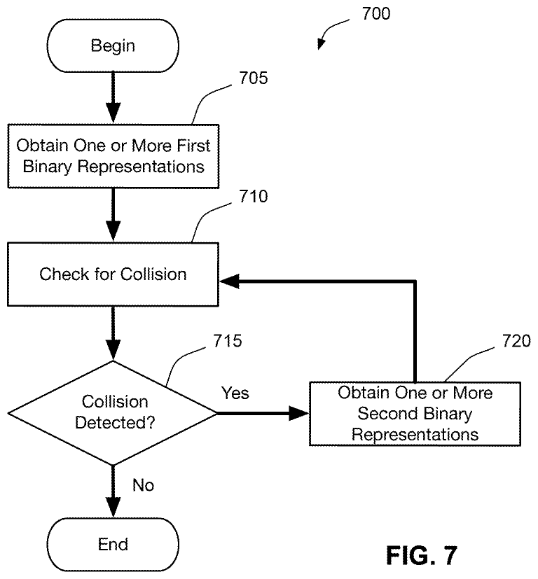

FIG. 7 shows an illustrative process 700 for adaptively resolving metadata labels into binary representations, in accordance with some embodiments. The inventors have recognized and appreciated that it may be desirable to perform the process 700 prior to installing concrete rules into a rule cache in hardware (e.g., the illustrative rule cache 144 in the example of FIG. 1). For instance, part or all of the process 700 may be performed at compile time, link time, and/or load time by the illustrative policy compiler 220, the illustrative policy linker 225, and/or the illustrative loader 215 in the example of FIG. 2.

At act 705, one or more first binary representations may be obtained. For instance, the one or more first binary representations may be received as input. Additionally, or alternatively, one or more metadata labels may be resolved into one or more respective binary representations (e.g., using hashing and/or graph traversal as described above in connection with the examples of FIGS. 5-6). The one or more metadata labels may include one or more input metadata labels and/or one or more output metadata labels of a concrete rule to be installed into a rule cache. For example, the one or more input metadata labels may be part of an input pattern that triggers a symbolic rule in a policy to be enforced. Such an input pattern may be identified in any suitable manner, such as using a Boolean satisfiability solver as described above in connection with the example of FIG. 4.

At act 710, the one or more first binary representations may be checked for collision. For instance, the one or more first binary representations may be hashed, and a result may be used to look up a list of concrete rules with corresponding hashes. If there is a concrete rule with a matching hash, that concrete rule may be retrieved, and may be compared against the one or more first binary representations to determine if the one or more first binary representations indeed matches the concrete rule, or if there is a collision.

In some embodiments, if there is no concrete rule with a matching hash, it may be determined at act 715 that there is no collision. Additionally, or alternatively, if there is a concrete rule with a matching hash, and the one or more first binary representations indeed matches the concrete rule, it may be determined at act 715 that there is no collision. The one or more first binary representations may be used to resolve the concrete rule into binary form, and the concrete rule in binary form may be added to the list of concrete rules with corresponding hashes.

On the other hand, if there is a concrete rule with a matching hash, but the concrete rule does not match the one or more first binary representations, it may be determined at act 715 that there is a collision. The process 700 may then proceed to act 720, where one or more second binary representations may be obtained.

In some embodiments, the one or more second binary representations may be obtained by replacing at least one of the one or more first binary representations with a different binary representation. For instance, a different binary representation may be generated for at least one input metadata label of the one or more input metadata labels represented, respectively, by the one or more first binary representations. This may be done in any suitable manner, for example, by incrementing a counter that keeps track of a number of binary representations that have been generated so far.

In some embodiments, the process 700 may return to act 710 to check the one or more second binary representations for collision, for example, by hashing and looking up the list of concrete rules with corresponding hashes. This may be repeated until one or more binary representations are identified that do not cause a collision.

The inventors have recognized and appreciated that the process 700 may lead to different binary representations for a same metadata label. For instance, a dictionary (e.g., as described above in connection with the examples of FIGS. 5-6) may map a metadata label to a first binary representation, which may be replaced at act 720 with a second binary representation. Accordingly, in some embodiments, such a dictionary may be updated so as to map the metadata label to the second binary representation.

The inventors have further recognized and appreciated that a metadata label may occur in multiple concrete rules. Accordingly, in some embodiments, if a metadata label is mapped to a different binary representation at act 720, one or more other concrete rules that also include the metadata label may be identified from the list of concrete rules with corresponding hashes. Such a concrete rule may be updated with the newly mapped binary representation, and a new hash may be generated based on the newly mapped binary representation. Even if an input pattern of such a concrete rule was checked for collision via the process 700 when that concrete rule was first added to the list of concrete rules with corresponding hashes, the process 700 may be repeated to ensure the newly mapped binary representation does not introduce a collision. Thus, it may be possible that the process 700 may be performed many times until all desired concrete rules have up-to-date binary representations, and there is still no collision. It may even be possible that such a collision-free configuration may never be reached.

While a list of concrete rules with corresponding hashes is described above in connection with the example of FIG. 7, it should be appreciated that aspects of the present disclosure are not so limited. In some embodiments, the process 700 may be performed using a rule cache in hardware. For instance, the process 700 may be performed at run time, using the illustrative rule cache 144 in the example of FIG. 1, by the illustrative tag processing hardware 140 and/or the illustrative policy processor 150.

The inventors have recognized and appreciated that implementing a rule cache in hardware as a hash table may incur significant costs in terms of chip area. For instance, an input pattern may be stored for each concrete rule installed into the rule cache, which may use a significant amount of RAM. As a result, more chip area may be used to provide the RAM.

Accordingly, in some embodiments, techniques are provided for reducing or even eliminating storage of input patterns. For instance, if a concrete rule's input pattern is hashed to a certain address, a single bit may be stored at that address to indicate the address is not empty, without storing the input pattern itself. Additionally, or alternatively, an output pattern of the concrete rule may be stored at the address, and may be returned if a query input pattern is hashed to that address. This may, in some instances, result in an 100× reduction in RAM size and hence chip area.

The inventors have further recognized and appreciated that different concrete rules may share a same output pattern, despite having different input patterns. Accordingly, in some embodiments, storage may be further reduced by storing only one copy of an output pattern, for example, in an output pattern table. For each concrete rule having that output pattern, a corresponding rule cache entry may store an address to the copy of the output pattern, instead of the output pattern itself. This may, in some instances, result in a further 4× reduction in RAM size and hence chip area.

The inventors have recognized and appreciated that, in an embodiment where a concrete rule's input pattern (which is hashed to form an address for the concrete rule) is not stored, a rule cache collision may lead to an incorrect application of the concrete rule. For instance, a query input pattern may be different from the concrete rule's input pattern, but may hash to the same address. It may be incorrect to trigger the concrete rule on this query input pattern. To avoid (e.g., reduce or eliminate) such incorrect applications, techniques such as those described in connection with the example of FIG. 7 may be used to avoid rule cache collisions.

However, as discussed above, resolving one input pattern at a time may be inefficient, because the illustrative process 700 may be iterated many times to propagate a newly mapped binary representation to all relevant concrete rules. The inventors have recognized and appreciated that it may be more efficient to resolve input patterns in a batched manner. For instance, in some embodiments, a batch of multiple input patterns may be resolved at once by using a Boolean satisfiability solver, or some other suitable technique, to identify binary representations for a batch of multiple metadata labels such that rule cache collisions are reduced or eliminated.

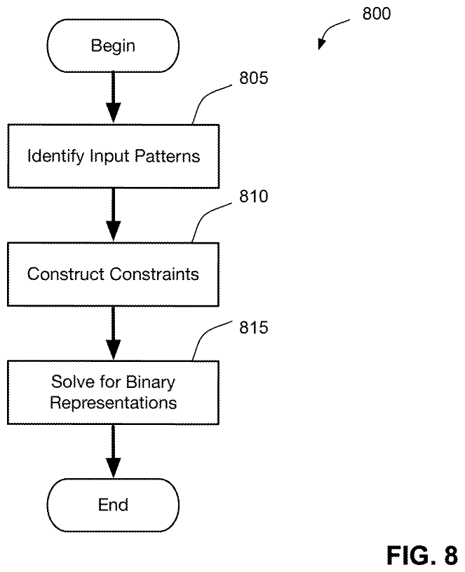

FIG. 8 shows an illustrative process 800 for resolving a batch of input patterns, in accordance with some embodiments. The inventors have recognized and appreciated that it may be desirable to perform the process 800 prior to installing concrete rules into a rule cache in hardware (e.g., the illustrative rule cache 144 in the example of FIG. 1). For instance, part or all of the process 800 may be performed at compile time, link time, and/or load time by the illustrative policy compiler 220, the illustrative policy linker 225, and/or the illustrative loader 215 in the example of FIG. 2.

At act 805, a batch of input patterns to be resolved may be identified. The inventors have recognized and appreciated that, given a certain rule cache size, a likelihood of rule cache collision may increase with a number of input patterns to be resolved. Therefore, it may be desirable to reduce a number of input patterns to be resolved. Accordingly, in some embodiments, techniques such as those described above in connection with the example of FIG. 4 may be used to identify input patterns that trigger one or more symbolic rules in one or more policies to be enforced. Such input patterns may include one or more input patterns corresponding to instructions to be allowed and/or one or more input patterns corresponding to instructions to be disallowed explicitly.

However, as discussed above in connection with the example of FIG. 4, run time performance may not be of concern for instructions to be disallowed. Accordingly, in some embodiments, some or all input patterns corresponding to instructions to be allowed may be identified, and may be included in the batch of input patterns to be resolved. Input patterns corresponding to instructions to be disallowed explicitly may or may not be included.

Additionally, or alternatively, priority levels may be associated with input patterns in a suitable manner. Some or all input patterns having a priority level higher than a selected threshold may be identified, and may be included in the batch of input patterns to be resolved. Input patterns having a priority level lower than the selected threshold may or may not be included.

At act 810, one or more constraints may be constructed. Such a constraint may include a condition involving one or more variables. For instance, each input pattern identified at act 805 may be associated with a respective address variable. A value for such a variable may indicate a rule cache address at which the corresponding input pattern may be stored.

Additionally, or alternatively, some or all possible metadata labels may be identified for each input (e.g., code and env in the illustrative signalSafety policy in the example of FIG. 3). This may be done, for example, using one or more of the illustrative techniques described herein, such as sum type, domain, etc. Each such metadata label may be associated with a respective integer variable. A bit string representing a value for such a variable may be used as a binary representation of the corresponding metadata label.

In some embodiments, a constraint may be constructed for each input pattern identified at act 805. As an example, given such an input pattern P=<L₀, . . . , L_{S-1}>, a constraint may be constructed as follows:

p=H(l₀, . . . ,l_{S-1})

where H is a suitable hash function, p is an address variable associated with the input pattern P, s is a number of input slots, and l₀, l_{S-1}, are integer variables associated with the metadata labels L₀, . . . , L_{S-1}, respectively. This constraint may provide that a rule cache address at which the input pattern P is to be stored matches a hash of the input pattern P in binary form.

Additionally, or alternatively, a constraint may be constructed as follows:

(not p₀ = p₁) and (not p₀ = p₂) and ... and (not p₀ = p_{K-1}) and
(not p₁ = p₂) and (not p₁ = p₀) and ... and (not p₁ = p_{K-1}) and
...
(not p_{K-2} = p_{K-1}),

where K is a number of input patterns identified at act 805, and p₀, . . . , p_{K-1} are address variables associated, respectively, with such input patterns.

The illustrative constraint above may provide that there is no collision between any pair of these input patterns. However, it should be appreciated that aspects of the present disclosure are not limited to eliminating all such collisions. In some embodiments, one or more such collisions may be tolerated, for example, by omitting one or more of the above conjuncts.

The inventors have recognized and appreciated that, in an embodiment where input patterns themselves are not stored in a rule cache, it may be desirable to avoid collisions between an input pattern corresponding to instructions to be allowed and an input pattern corresponding to instructions to be disallowed, because such a collision may lead to a disallowed instruction being allowed incorrectly. Accordingly, a constraint may be constructed to provide that an input pattern corresponding to instructions to be disallowed does not collide with any input pattern corresponding to instructions to be allowed.

For instance, as discussed above, a set of possible metadata labels may be identified for each input (e.g., code and env in the signalSafety policy). Thus, there may be sets A₀, . . . , A_{S-1}, where S is the number of input slots. In some embodiments, a set of possible input patterns may be constructed as a Cartesian product A₀ X . . . X A_{S-1}, or a subset thereof. A set of disallowed input patterns may then be constructed by removing allowed input patterns from this Cartesian product.

In some embodiments, given a disallowed input pattern Q=<L₀, . . . , L_{S-1}>, a constraint may be constructed as follows:

(not p₀=H(l₀, . . . l_{S-1}) and . . . and (not p_{K-1}=H(l₀, . . . l_{S-1}))

where K is the number of input pattern identified at act 805, p₀, . . . , p_{K-1} are the address variables associated, respectively, with such input patterns, H is the hash function, s is the number of input slots, and lₒ, . . . , l_{S-1}, are integer variables associated with the metadata labels L₀, . . . , L_{S-1}, respectively.

The illustrative constraint above may provide that there is no collision between the disallowed input pattern Q and any of the input patterns identified at act 805 (which may include input patterns corresponding to instructions to be allowed). However, it should be appreciated that aspects of the present disclosure are not limited to eliminating all such collisions. In some embodiments, one or more such collisions may be tolerated, for example, by omitting one or more of the above conjuncts.

In some embodiments, a constraint similar to the illustrative constraint above may be constructed for each disallowed input pattern. However, it should be appreciated that aspects of the present disclosure are not limited to eliminating all such collisions. In some embodiments, one or more collisions may be tolerated, for example, by omitting one or more constraints corresponding, respectively, to one or more disallowed input patterns.

At act 815, a Boolean satisfiability solver may be used to solve for one or more of the integer variables and one or more of the address variables subject to one or more of the constraints constructed at act 810. Any suitable Boolean satisfiability solver may be used, including, but not limited to, a satisfiability modulo theories (SMT) solver.

In some embodiments, a solution returned by the solver may include a value for an integer variable corresponding to a metadata label. A bit string representing that value may be used as a binary representation of the metadata label.

Additionally, or alternatively, the solution may include a value for an address variable corresponding to an input pattern identified at act 805. Because of the corresponding constraint, the input pattern in binary form may be hashed to the address value, and therefore may be installed into a rule cache at the address value.

Although details of implementation are described above in connection with the example FIG. 8, it should be appreciated that aspects of the present disclosure are not limited to any particular manner of implementation. For instance, in some embodiments, part or all of the process 800 may be performed at run time by the illustrative tag processing hardware 140 and/or the illustrative policy processor 150 in the example of FIG. 1.

Moreover, aspects of the present disclosure are not limited to using a Boolean satisfiability solver to resolve a batch of input patterns. In some embodiments, a batch of input patterns may be resolved by using an optimization technique to select one or more binary representations. For instance, one or more exact and/or approximate optimization techniques (e.g., simulated annealing) may be used to select binary representations so as to increase one or more scores based on concrete rules installed into a rule cache.

As one example, a concrete rule installed into a rule cache may be assigned a score of 1, and a sum of the scores of all installed concrete rules may be optimized. Thus, a solution may advantageously fit a large number of concrete rules into the rule cache, while reducing or eliminating collisions.

As another example, priority levels may be associated with concrete rules in a suitable manner. A concrete rule installed into a rule cache may be assigned a score based on a priority level associated with that concrete rule, and a sum of the scores of all installed concrete rules may be optimized. Thus, a solution may advantageously fit a large number of high-priority concrete rules into the rule cache, while reducing or eliminating collisions.

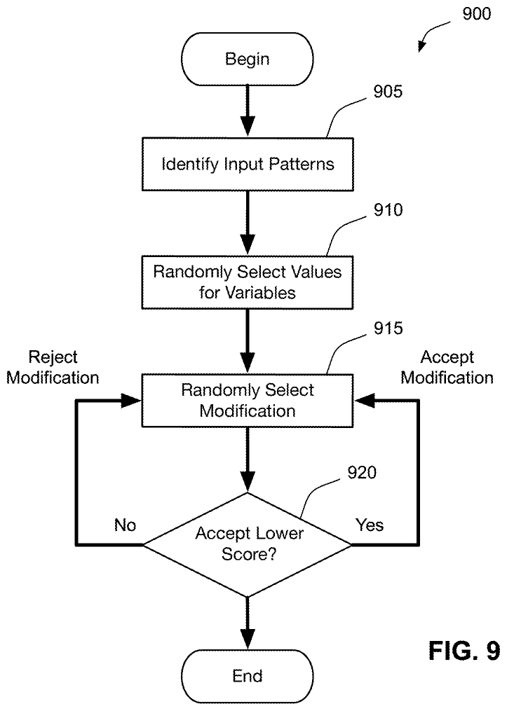

FIG. 9 shows an illustrative process 900 for resolving a batch of input patterns, in accordance with some embodiments. Like the illustrative process 800 in the example of FIG. 8, part or all of the process 900 may be performed at compile time, link time, and/or load time by the illustrative policy compiler 220, the illustrative policy linker 225, and/or the illustrative loader 215 in the example of FIG. 2. Additionally, alternatively, part or all of the process 900 may be performed at run time by the illustrative tag processing hardware 140 and/or the illustrative policy processor 150 in the example of FIG. 1.

At act 905, a batch of input patterns may be identified as described above in connection with act 805 of the process 800. Each metadata label that occurs in at least one identified input pattern may be associated with a respective integer variable, as described above in connection with act 810. However, instead of (or in addition to) constructing constraints and using a Boolean satisfiability solver to solve for binary representations, one or more exact and/or approximate optimization techniques (e.g., simulated annealing) may be used to select binary representations.

In some embodiments, an optimization technique may proceed through a selected number of iterations. Initially, at act 910, values may be randomly selected for all integer variables. A rule cache configuration based on the randomly selected values may be evaluated to determine a score. For instance, the score may be based on a number of collisions found in the configuration. Additionally, or alternatively, the score may be based on priority levels of installed concrete rules (e.g., a sum of such priority levels), assuming that, where there is a collision, a higher priority rule is selected over a lower priority rule.

The inventors have recognized and appreciated that a metadata label that occur in relatively many input patterns may have a greater impact than a metadata label that occur in relatively few input patterns. For instance, a change in binary representation for a frequently occurring metadata label may lead to changes in binary representation for many input patterns. Therefore, it may be advantageous to cause the optimization technique to prioritize frequently occurring metadata labels.

Accordingly, in some embodiments, a configuration score may be based on one or more metadata label scores, in addition to, or instead of, a number of collisions and/or priority levels of installed concrete rules. For instance, a metadata label may be associated with a metadata label score based on a number of input patterns identified at act 905 in which the metadata label appears, such that a frequently occurring metadata label may have a higher score than an infrequently occurring metadata label. The configuration score may then be determined based on scores of metadata labels that are not involved in any collision (e.g., a sum of such metadata label scores).

Within each iteration, at act 910, a modification to a current configuration may be randomly selected. In some embodiments, the modification may include a newly selected value for exactly one integer variable. However, it should be appreciated that aspects of the present disclosure are not so limited. In some embodiments, the modification may include newly selected values for multiple integer variables, respectively.

In some embodiments, a configuration resulting from the randomly selected modification may be evaluated to determine a score. This may be done in a similar manner as the evaluation of the initial configuration, as described above.

At act 920, it may be determined whether to accept or reject the modification selected at act 910. In some embodiments, this determination may be made based on a score of the current configuration, a score of the modified configuration, and/or a temperature. For instance, the modification may be accepted if the score of the modified configuration is higher than a sum of the score of the current configuration and the temperature. However, it should be appreciated that aspects of the present disclosure are not limited to making this determination in any particular manner.

In some embodiments, the temperature may be initialized to a positive value, and may be decreased at each iteration. Thus, earlier in the process 900, when the temperature is higher, a modification that results in a lower score may have a higher likelihood of being accepted. This may promote exploration of the search space, thereby reducing a likelihood of being stuck at a local maximum and missing a global maximum. By contrast, later in the process 900, when the temperature is lower, a modification that results in a lower score may have a higher likelihood of being rejected. This may help the process 900 converge to a local maximum before terminating.

In some embodiments, a solution returned by the process 900 may include a value for an integer variable corresponding to a metadata label. A bit string representing that value may be used as a binary representation of the metadata label.

Additionally, or alternatively, the solution returned by the process 900 may be checked for collision. If two concrete rules are found with input patterns that hash to a same address, a higher priority rule may be selected over a lower priority rule.

The inventors have recognized and appreciated that, in some instances, a solution returned by the process 900 may not completely fill up a rule cache. Accordingly, in some embodiments, one or more concrete rules may be added. For instance, the solution returned by the process 900 may only include concrete rules corresponding to instructions to be allowed. If such concrete rules do not completely fill up a rule cache, concrete rules that correspond to instructions to be disallowed explicitly may be added.

Additionally, or alternatively, the solution returned by the process 900 may only include concrete rules having priority levels higher than a selected threshold. If such concrete rules do not completely fill up a rule cache, concrete rules having lower priority levels may be added.

In some embodiments, a concrete rule to be added may be checked for collision. For instance, if a concrete rule corresponding to instructions to be disallowed explicitly collides with a concrete rule corresponding to instructions to be allowed, the former may not be added. Likewise, if a concrete rule having a lower priority level collides with a concrete rule having a higher priority level, the former may not be added.

Although details of implementation are described above in connection with the example FIG. 9, it should be appreciated that aspects of the present disclosure are not limited to any particular manner of implementation. For instance, in some embodiments, gradient descent, branch and bound, and/or one or more other optimization techniques may be used instead of, or in addition to, simulated annealing.

As discussed above, the inventor has recognized and appreciated that run time performance may be improved by installing concrete rules ahead of time into the illustrative rule cache 144 in the example of FIG. 1, so that fewer queries may be made to the illustrative policy processor 150 at run time. However, the rule cache 144 may have limited capacity (e.g., to conserve area on a chip), and therefore may not be able to hold all concrete rules that may be encountered at run time. Accordingly, in some embodiments, techniques are provided for prioritizing concrete rules for installation into a rule cache. For instance, a policy language feature may be provided for associating a metadata symbol with a priority level. Additionally, alternatively, a policy language feature may be provided for associating a policy rule with a priority level.

In some embodiments, the illustrative policy compiler 220 in the example of FIG. 2 may be programmed to retain priority information through compilation. For instance, a concrete rule including a metadata symbol may be associated with a priority level that is at least as high as a priority level associated with the metadata symbol. Additionally, or alternatively, a concrete rule resulting from a policy rule may be associated with a priority level that is at least as high as a priority level associated with the policy rule. Thus, a concrete rule including one or more metadata symbols and/or resulting from a policy rule may be associated with a highest priority level among one or more priority levels of the one or more metadata symbols and/or the policy rule.

In some embodiments, concrete rules may be installed into the rule cache 144 according to associated priority levels. For instance, concrete rules associated with a highest level of priority may be installed first. If the rule cache 144 is not yet full, concrete rules associated with a next highest level of priority may be installed. This may be repeated until the rule cache 144 is full. In this manner, higher priority concrete rules may be accessed from the rule cache 144 at run time, while lower priority concrete rules may be computed by the policy processor 150 at run time.

In some embodiments, a first concrete rule computed by the policy processor 150 at run time may be installed into the rule cache 144, replacing a second concrete rule already in the rule cache 144. This may happen if the first concrete rule collides with the second concrete rule, and/or if the rule cache 144 is full. Before making such a replacement, a priority level of the first concrete rule may be compared against the priority level of the second concrete rule. The replacement may be made only if the first concrete rule is of a same or higher priority compared to the second concrete rule.

In some embodiments, the rule cache 144 may be hierarchical. For instance, the rule cache 144 may include a Level 1 (L1) cache and/or a Level 2 (L2) cache. The L1 cache may be in a faster RAM, whereas the L2 cache may be in a slower RAM or a main memory. Thus, installation of concrete rules may start with the L1 cache, for example, according to priority levels of the concrete rules, as discussed above. When the L1 cache is full, the process may continue with the L2 cache. In this manner, an input pattern matching a concrete rule associated with a higher priority may be processed more quickly than an input pattern matching a concrete rule associated with a lower priority.

It should be appreciated that aspects of the present disclosure are not limited to using a hierarchical cache having any particular number of levels, or a hierarchical cache at all. Moreover, aspects of the present disclosure are not limited to installing concrete rules into a hierarchical rule cache based on priority levels. In some embodiments, concrete rules corresponding to instructions to be allowed may be identified and installed into an L1 cache, whereas concrete rules corresponding to instructions to be disallowed explicitly may be identified and installed into an L2 cache.

The inventors have recognized and appreciated that, in some instances, it may not be practical to accommodate all allowed concrete rules without collision using a 10-bit hash size, but it may be practical to do so using a 32-bit hash size. Accordingly, in some embodiments, techniques are provided for efficiently storing such concrete rules using multiple hash sizes.

For instance, one or more techniques such as those described in connection with FIGS. 8-9 may be used to resolve input patterns of allowed and/or explicitly disallowed concrete rules into binary representations, assuming a 32-bit hash size. Given such a concrete rule, a 10-bit hash and a 32-bit hash may be generated from an input pattern of the concrete rule. In some embodiments, the 10-bit hash may be generated based on the 32-bit hash. For instance, the 10-bit hash may be a designated portion (e.g., lower 10 bits) of the 32-bit hash.

In some embodiments, the 10-bit hash may be used as an address to install the concrete rule into a rule cache (e.g., the illustrative rule cache 144 in the example of FIG. 1). The remaining portion (e.g., upper 22 bits) of the 32-bit hash may be stored at the 10-bit address, without storing the input pattern itself. Additionally, or alternatively, an output pattern of the concrete rule, and/or an address to a copy of the output pattern, may be stored at the 10-bit L1 address. In this manner, less chip area may be used to implement the rules cache 144.

In some embodiments, a 32-bit hash may be generated from a query input pattern. A 10-bit hash may be generated based on the 32-bit hash, and may be used to look up the rule cache 144. For instance, the 10-bit hash may be a designated portion (e.g., lower 10 bits) of the 32-bit address. In case of a rule cache miss, it may be determined that a corresponding instruction is to be disallowed. In case of a rule cache hit, the remaining portion (e.g., upper 22 bits) of the 32-bit hash may be compared against what is returned by the rule cache 144.

If there is a match, it may be determined that the corresponding instruction is to be allowed or explicitly disallowed, whichever is applicable, based on what is returned by the rule cache 144. Otherwise, a policy processor (e.g., the illustrative policy processor 150 in the example of FIG. 1) may be invoked with the query input pattern, and/or some other suitable processing may be performed.

It should be appreciated that aspects of the present disclosure are not limited to generating a 10-bit hash based on a 32-bit hash. In some embodiments, two separate hash functions may be used. For instance, a hash function H1 may be used to generate a 10-bit hash, and a hash function H2 may be used to generate a 32-bit hash. The 10-bit hash may be used as a rule cache address at which the 32-bit hash may be stored. Similarly, given a query input pattern, the hash function H1 may be used to generate a 10-bit hash, which may be used to look up the rule cache 144. In case of a rule cache miss, it may be determined that a corresponding instruction is to be disallowed. In case of a rule cache hit, the hash function H2 may be used to generate a 32-bit hash, which may be compared against what is returned by the rule cache 144.

In some embodiments, a hierarchical cache may be used in conjunction with one or more of the illustrative techniques described above with multiple hash sizes. For instance, an L1 cache may be used that has a 10-bit address space, and an L2 cache may be used that has a 14-bit address space. Given an allowed and/or explicitly disallowed concrete rule, a 32-bit hash may be generated from an input pattern of the concrete rule. A designated 10-bit portion (e.g., lower 10 bits) of the 32-bit hash may be used as an address at which the 32-bit hash, or a remaining portion (e.g., upper 22 bits) thereof, may be stored in the L1 cache.

Additionally, or alternatively, a designated 14-bit portion (e.g., lower 14 bits) of the 32-bit hash may be used as an address at which the 32-bit hash, or a remaining portion (e.g., upper 18 bits) thereof, may be stored in the L2 cache. In this manner, if a query input pattern produces a hit in the L1 cache, but does not match what is returned by the L1 cache, a look up may be performed in the L2 cache.

In some embodiments, a lower-level cache (e.g., L2, L3, etc.) may have a 32-bit or even larger address space. For instance, such a lower-level cache may be implemented in a main memory. As a result, all allowed and/or explicitly disallowed concrete rules may be accommodated without collision. In this manner, the policy processor 150 may not be invoked at all, which may improve run time performance.

It should be appreciated that aspects of the present disclosure are not limited to using a 10-bit hash size, a 32-bit hash size, or any particular hash size. Likewise, aspects of the present disclosure are not limited to using any cache with a 10-bit address space, a 14-bit address space, a 32-bit address space, or any particular address space.

The inventors have recognized and appreciated that, in some instances, despite one or more of the above techniques being used to install concrete rules into the rule cache 144 ahead of time, an input pattern may be encountered that has no match in the rule cache 144. As a result, the policy processor 150 may be queried, which may cause an undesirable delay.

Accordingly, techniques are provided for improving efficiency of the policy processor 150. For instance, in some embodiments, the policy processor 150 may be programmed to search for a concrete rule that matches an input pattern, from a set of concrete rules generated ahead of time. This search may be performed instead of, or in addition to, evaluating a symbolic rule in response to being queried with the input pattern.

In some embodiments, symbolic rules in a policy may be combined using a priority operator, such as the “\hat{ }” operator in the illustrative signalsafety policy in the example of FIG. 3. Such an operator may have a semantics that is dependent upon evaluation order. For instance, the eighth rule and the sixteenth rule in the signalsafety policy (reproduced below) may have conditions that are not mutually exclusive. In that respect, an input pattern with {GoGreenNS} on the input code and {NS_Yellow, EW_Green} on the input env may match both rules. The eighth rule may be triggered on this input pattern, because the eighth rule is listed before the sixteenth rule. Had the eighth rule been listed after the sixteenth rule, the sixteenth rule may have been triggered instead of the eighth rule, resulting in a different error message.

```
\hat{ } rule_8 (code == [+GoGreenNS], env == [+EW_Green] ->
  fail “Safety Violation - East-West Lights Still Green”)
...
\hat{ } rule_16 (code == _ , env == [NS_Yellow, EW_Green] ->
  fail “Safety Violation - Neither Set of Lights Is Red”)
```

The inventors have recognized and appreciated that sequential evaluation may provide convenience for policy authoring. For instance, a policy author may prioritize a more specific rule over a more general rule simply by placing the more specific rule before the more general rule, without explicitly calling out the more specific rule as an exception to the more general rule.

However, the inventor has also recognized and appreciated that sequential evaluation may lead to certain inefficiencies. For instance, referring to the eighth rule and the ninth rule in the signalSafety policy (reproduced below), the eighth rule may not be triggered on an input pattern because the input code does not match “+GoGreenNS.” In that case, it may be unnecessary to evaluate the ninth rule on the same input pattern, because the ninth rule also may not be triggered, for the same reason. Under sequential evaluation, the ninth rule may nevertheless be evaluated, which may be wasteful.

```
\hat{ } rule_8 (code == [ +GoGreenNS] , env == [+EW_Green] ->
  fail “Safety Violation - East-West Lights Still Green”)
\hat{ } rule_9 (code == [+GoGreenNS], env == [+EW_Yellow] ->
  fail “Safety Violation - East-West Lights Still Yellow”)
```

The inventors have further recognized and appreciated that, unlike symbolic rules, concrete rules may have conditions that are mutually exclusive. Therefore, evaluation of concrete rules may be order independent. Accordingly, in some embodiments, a set of concrete rules may be arranged in a selected order for efficient evaluation.

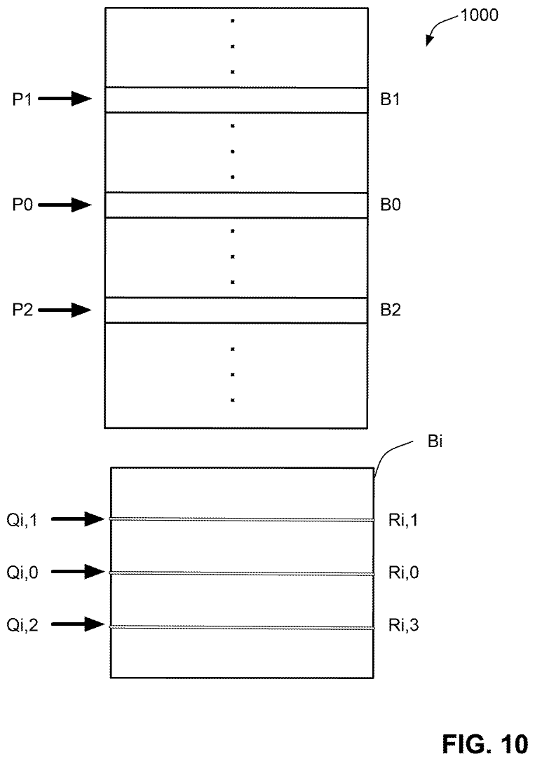

FIG. 10 shows an illustrative arrangement 1000 of concrete rules, in accordance with some embodiments. For instance, the arrangement 1000 may be used at run time by the illustrative policy processor 150 in the example of FIG. 1 to determine if an input pattern matches any of the concrete rules.

In some embodiments, a plurality of Boolean variables appearing in the concrete rules may be ordered by input (e.g., code, env, etc.). As an example, the following ordering may be used for Boolean variables in the signalSafety policy.

code_NS_Red, code_NS_Yellow, code_NS_Green,
code_EW_Red, code_EW_Yellow, code_EW_Green,
code_GoRedNS, code_GoYellowNS, code_GoGreenNS,
code_GoRedEW, code_GoYellowEW, code_GoGreenEW,
env_NS_Red, env_NS_Yellow, env_NS_Green,
env_EW_Red, env_EW_Yellow, env_EW_Green,
env_GoRedNS, env_GoYellowNS, env_GoGreenNS,
env_GoRedEW, env_GoYellowEW, env_GoGreenEW

The inventors have recognized and appreciated that a condition of a concrete rule may correspond to an assignment of truth values to the above Boolean variables. Each such assignment may correspond to a binary string based on the above ordering. For instance, code_NS_Red may correspond to a most significant bit, whereas env_GoGreenEW may correspond to a least significant bit. In this manner, the concrete rules may be ordered based on the usual “less than” ordering on binary strings.

In some embodiments, the concrete rules may be organized into blocks, where each block may correspond to an assignment of truth values to all of the code Boolean variables. Thus, there may be up to 2\hat{ }\12=4096 blocks, each block corresponding to a respective 12-bit prefix for a 24-bit binary string. However, it should be appreciated that there may be fewer than 4096 blocks. For instance, there may be no concrete rule with the prefix 1111 1111 1111.

In some embodiments, one or more pointers may be provided, each pointing to a respective block. For instance, a pointer p₀ may be provided that points to a block B₀ where a number of concrete rules in all blocks B less than B₀ may be roughly a half of a total number of concrete rules, a pointer p₁ may be provided that points to a block B₁ where a number of concrete rules in all blocks B less than B₁ may be roughly a quarter of the total number of concrete rules, a pointer p₂ may be provided that points to a block B₂ where a number of concrete rules in all blocks B less than B₂ may be roughly three quarters of the total number of concrete rules, and so on. This may be repeated to obtain pointers p₃, p₄, p₅, p₆, . . . and blocks B₃, B₄, B₅, B₆, . . . , until there is only one block left between two adjacent pointers. In some embodiments, for each block Bᵢ, one or more pointers may be provided, each pointing to a respective rule. For instance, a pointerQ_{i,0} may be provided that points to a rule R_{i,0} where a number of concrete rules in the block Bᵢ that are less than R_{i,0} may be roughly a half of a total number of such concrete rules, a pointer Q_{i,1} may be provided that points to a rule R_{i,1} where a number of concrete rules in the block Bᵢ that are less than R_{i,1} may be roughly a quarter of a total number of such concrete rules, a pointer Q_{i,2} may be provided that points to a rule R_{i,2} where a number of concrete rules in the block Bᵢ that are less than R_{i,2} may be roughly three quarters of a total number of such concrete rules, and so on. This may be repeated to obtain pointers Q_{i,3}, Q_{i,4}, Q_{i,5}, Q_{i,6}, . . . and rules R_{i,3}, R_{i,4}, R_{i,5}, R_{i,6}, . . . , until there is only one rule left between two adjacent pointers.

In some embodiments, a metadata label L for the input code in a given input pattern may be compared against B₀. If L is less than B₀, then L may be compared against B₁. Otherwise, L may be compared against B₂. This may be repeated until a block B₁ is identified that matches L, or it is determined that no such block is found. If no such block is found, it may be determined that the input pattern does not match any concrete rule.

In some embodiments, if a block B₁ is identified that matches L, a metadata label M for the input env in the given input pattern may be compared against R_{i,0}. If M is less than the last 12 bits of R_{i,0}, then L may be compared against R_{i,1}. Otherwise, M may be compared against R_{i,2}. This may be repeated until a rule R_{i,j} is identified that matches M, or it is determined that no such rule is found. If no such rule is found, it may be determined that the input pattern does not match any concrete rule.

The inventors have recognized and appreciated that, using the illustrative technique described above, only log(N) comparisons may be performed to determine if an input pattern matches a concrete rule, where N is the total number of concrete rules. Moreover, the illustrative technique described above may be used for concrete rules with more than two inputs, for example, by dividing blocks into sub-blocks, each sub-block corresponding to a respective 12-bit substring.

Although details of implementation are described above in connection with the example FIG. 10, it should be appreciated that aspects of the present disclosure are not limited to any particular manner of implementation. For instance, in some embodiments, concrete rules may not be divided into blocks. Instead, a pointer p₀ may be provided that points to a rule R₀ where a number of concrete rules less than R₀ may be roughly a half of a total number of concrete rules, a pointer p₁ may be provided that points to a rule R₁ where a number of concrete rules in less than R₁ may be roughly a quarter of the total number of concrete rules, a pointer p₂ may be provided that points to a rule R₂ where a number of concrete rules less than R₂ may be roughly three quarters of the total number of concrete rules, and so on. This may be repeated to obtain pointers p₃, p₄, p₅, p₆, . . . and rules R₃, R₄, R₅, R₆, . . . , until there is only one rule left between two adjacent pointers.

In some embodiments, a given input pattern P may be compared against R₀. If P is less than R₀, then P may be compared against R₁. Otherwise, P may be compared against R₂. This may be repeated until a rule R₃ is identified that matches P, or it is determined that no such rule is found. If no such rule is found, it may be determined that the input pattern does not match any concrete rule.

Illustrative configurations of various aspects of the present disclosure are provided below.
1. A computer-implemented method for resolving input patterns into binary representations, comprising acts of: identifying a plurality of input patterns, wherein an input pattern of the plurality of input patterns comprises a metadata label; selecting a plurality of respective values for a plurality of variables, wherein the plurality of variables comprise a variable corresponding to the metadata label of the input pattern; and obtaining a binary representation of the metadata label based on the respective value of the variable.
2. The method of configuration 1, wherein: the method further comprises an act of constructing a plurality of constraints corresponding, respectively, to the plurality of input patterns; a constraint of the plurality of the constraints corresponds to the input pattern comprising the metadata label; the constraint references a variable corresponding to the metadata label; and selecting the plurality of respective values for the plurality of variables comprises solving, subject to the plurality of constraints, for the plurality of variables to obtain the plurality of respective values.
3. The method of configuration 2, wherein: the variable comprises a first variable; the constraint further references a second variable of the plurality of variables; the constraint comprises a condition relating the first variable and the second variable.
4. The method of configuration 3, wherein: the condition indicates that the second variable matches a first expression comprising applying a selected hash function to a second expression comprising the first variable.
5. The method of configuration 4, wherein: the method further comprises an act of storing an entry for a concrete rule having the at least one input pattern in a rule cache; and the entry comprises at least a portion of the respective value of the second variable.
6. The method of configuration 5, wherein: the rule cache comprises a Level 1 (L1) cache and a Level 2 (L2) cache; the L1 cache has an address space that is smaller than an address space of the L2 cache; the entry comprises a first entry; the method further comprises acts of: obtaining a first address based on the respective value of the second variable, wherein the first entry is stored at a first address in the L1 cache; obtaining a second address based on the respective value of the second variable; and storing a second entry for the concrete rule at the second address in the L2 cache.
7. The method of configuration 2, wherein: the variable comprises a first variable; the plurality of variables further comprise a plurality of second variables; the constraint comprises a first constraint; the plurality of variables are solved further subject to a second constraint indicating that the plurality of second variables have pairwise distinct values.
8. The method of configuration 2, wherein: the input pattern comprises a first input pattern; the method further comprises identifying a second input pattern that is not part of the plurality of input patterns; the metadata label comprises a first metadata label; the second input pattern comprises a second metadata label; the variable comprises a first variable; the plurality of variables further comprise a second variable corresponding to the second metadata label; the plurality of variables further comprise a plurality of third variables; the constraint comprises a first constraint; the plurality of variables are solved further subject to a second constraint indicating that none of the plurality of second variables matches a first expression comprising applying a selected hash function to a second expression comprising the second variable.
9. The method of configuration 2, wherein: identifying a plurality of input patterns comprises identifying at least one input pattern that triggers a symbolic rule in a policy to be enforced.
10. The method of configuration 9, wherein: the at least one input pattern corresponds to instructions to be allowed.
11. The method of configuration 2, wherein: identifying a plurality of input patterns comprises identifying at least one input pattern having a priority level higher than a selected threshold.
12. The method of configuration 1, wherein: selecting the plurality of respective values for the plurality of variables comprises using an optimization technique to select the plurality of respective values.
13. The method of configuration 12, wherein: the plurality of respective values comprise a plurality of respective final values; and using the optimization technique to select the plurality of respective values comprises: randomly selecting a plurality of respective intermediate values for the plurality of variables; and analyzing the plurality of respective intermediate values.
14. The method of configuration 13, wherein: the plurality of variables correspond, respectively, to a plurality of metadata labels; the plurality of metadata labels comprise the metadata label of the input pattern; and analyzing the plurality of respective intermediate values comprises: obtaining, based on the plurality of respective intermediate values, a plurality of respective intermediate binary representations for the plurality of metadata labels; substituting the plurality of respective intermediate binary representations for the plurality of metadata labels to resolve the plurality of input patterns into binary form; determining whether there is at least one collision in the plurality of input patterns in binary form.
15. The method of configuration 14, wherein: determining whether there is at least one collision in the plurality of input patterns in binary form comprises: applying a hash function to a first input pattern in binary form to obtain a first hash; applying the hash function to a second input pattern in binary form to obtain a second hash; and comparing the first hash and the second hash.
16. The method of configuration 13, wherein: a first score is obtained by analyzing the plurality of respective intermediate values; and using the optimization technique to select the plurality of respective values further comprises: randomly selecting a modification to the plurality of respective intermediate values; and analyzing a result of applying the modification to the plurality of respective intermediate values, thereby obtaining a second score.
17. The method of configuration 16, wherein: using the optimization technique to select the plurality of respective values further comprises determining whether to accept or reject the modification based on the first score, the second score, and a temperature.
18. The method of configuration 17, wherein: the optimization technique comprises a plurality of iterations; using the optimization technique to select the plurality of respective values further comprises: initializing the temperature to a positive value; and decreasing the temperature at one or more iterations of the plurality of iterations.
19. A computer-implemented method for resolving metadata labels into binary representations, comprising acts of: looking up a metadata label in a dictionary, the dictionary comprising a plurality of entries mapping metadata labels to respective binary representations; if the metadata label matches an entry in the dictionary, obtaining a binary representation to which the matching entry maps the metadata label; and if the metadata label does not match any entry in the dictionary, generating a new binary representation.
20. The method of configuration 19, wherein: the metadata label does not match an entry in the dictionary; and the method further comprises an act of adding an entry to the dictionary, the entry mapping the metadata label to the new binary representation.
21. The method of configuration 19, wherein: the method further comprises an act of maintaining a counter that counts a number of binary representations that have been generated; and the new binary representation comprises a binary string representing a value of the counter.
22. The method of configuration 19, wherein: the metadata label comprises a list of one or more metadata symbols.
23. The method of configuration 22, wherein: the list of one or more metadata symbols is sorted according to a selected ordering of metadata symbols.
24. The method of configuration 22, further comprising an act of: incrementally adding the one or more metadata symbols to the list as one or more policies are evaluated, the one or more policies referencing the one or more metadata symbols.
25. The method of configuration 19, wherein: the dictionary comprises a hash table; and looking up the metadata label in the dictionary comprises: applying a hash function to the metadata label; and if the metadata label is hashed to a non-empty bucket, determining whether the metadata label matches an entry in the non-empty bucket.
26. The method of configuration 19, wherein: the dictionary comprises a graph; the plurality of entries in the dictionary comprise a plurality of nodes in the graph; and looking up the metadata label in the dictionary comprises traversing the graph to identify a node that matches the metadata label.
27. The method of configuration 26, wherein: the graph comprises an edge from a first node to a second node; the first node corresponds to a first set of metadata symbols; the edge is labeled with at least one metadata symbol that is not in the first set of metadata symbols; and the second node corresponds to a second set of metadata symbol resulting from adding the at least one metadata symbol to the first set of metadata symbols.
28. The method of configuration 26, wherein: the graph comprises an edge from a first node to a second node; the first node corresponds to a first set of metadata symbols; the edge is labeled with at least one metadata symbol that is in the first set of metadata symbols; and the second node corresponds to a second set of metadata symbol resulting from removing the at least one metadata symbol from the first set of metadata symbols.
29. A computer-implemented method for identifying input patterns, comprising an act of: processing a policy rule to identify at least one input pattern, wherein: the policy rule comprises at least one condition on at least one input; the at least one input pattern comprises at least one metadata label corresponding to the at least one input; and the at least one metadata label satisfies the at least one condition on the at least one input.
30. The method of configuration 29, wherein: the at least one metadata label comprises a subset of a set of metadata symbols; and processing the policy rule to identify the at least one input pattern comprises selecting the subset from the set of metadata symbols.
31. The method of configuration 30, wherein: selecting the subset from the set of metadata symbols comprises identifying an assignment of truth values to metadata symbols in the set of metadata symbols; an assignment of 1 to a metadata symbol indicates the metadata symbol is in the subset; and an assignment of 0 to a metadata symbol indicates the metadata symbol is not in the subset.
32. The method of configuration 31, wherein: identifying the assignment of truth values to the metadata symbols comprises identifying an assignment that satisfies one or more constraints.
33. The method of configuration 32, wherein: identifying the assignment that satisfies the one or more constraints comprises converting the one or more constraints to disjunctive norm form; and the assignment corresponds to a disjunct of the one or more constraints in disjunctive norm form.
34. The method of configuration 32, wherein: identifying the assignment that satisfies the one or more constraints comprises solving, subject to the one or more constraints, for a plurality of Boolean variables corresponding, respectively, to the metadata symbols.
35. The method of configuration 32, wherein: the at least one condition of the policy rule references at least one metadata symbol in the set of metadata symbols; and the one or more constraints comprise at least one constraint based on the at least one condition.
36. The method of configuration 35, wherein: the at least one condition comprises a presence (or, respectively, an absence) of the at least one metadata symbol; and the at least one constraint assigns 1 (or respectively, 0) to the at least one metadata symbol.
37. The method of configuration 32, wherein: the at least one input is associated with a metadata type constructed based on a plurality of metadata types; and the one or more constraints comprise a constraint indicating that, if 1 is assigned to at least one metadata symbol of a metadata type of the plurality of metadata types, then 0 is assigned to every metadata symbol of every other metadata type of the plurality of metadata types.
38. The method of configuration 32, wherein: the at least one input comprises a first input; the at least one policy rule further comprises a second input; the first input is associated with a first subset of metadata symbols; the second input is associated with a second subset of metadata symbols that is disjoint from the first subset of metadata symbols; the one or more constraints comprise a first constraint for the first input, the first constraint assigning 0 to every metadata symbol in the second subset of metadata symbols; and the one or more constraints further comprise a second constraint for the second input, the second constraint assigning 0 to every metadata symbol in the first subset of metadata symbols.
39. A computer-implemented method for processing a query input pattern, comprising an act of: matching the query input pattern against a list of concrete rules, wherein: the query input pattern comprises a list of metadata labels <L0, . . . , LS-1> corresponding, respectively, to a list of inputs; each concrete rule of the list of concrete rules comprises a list of metadata labels <M0, . . . , MS-1> corresponding, respectively, to the list of inputs; the list of concrete rules is ordered according to a lexicographic ordering induced by a selected ordering on metadata labels; matching the query input pattern against the list of concrete rules comprises comparing <L0, . . . , LS-1> against a selected concrete rule R0 according to the lexicographic ordering; and a number of concrete rules R such that R is less than R0 according to the lexicographic ordering matches a number of concrete rules R such that R is greater than R0 according to the lexicographic ordering.
40. The method of configuration 39, wherein: each metadata label is encoded as a bit string; and the selected ordering on metadata labels is based on a selected ordering on bit strings.
41. A system comprising circuitry and/or one or more processors programmed by executable instructions, wherein the circuitry and/or the one or more programmed processors are configured to perform the method of any of configurations 1-40.
42. At least one computer-readable medium having stored thereon at least one netlist for the circuitry of configuration 41.
43. At least one computer-readable medium having stored thereon at least one hardware description that, when synthesized, produces the netlist of configuration 42.
44. At least one computer-readable medium having stored thereon the executable instructions of configuration 41.

Illustrative code for the signalSafety policy in the example of FIG. 3 is provided below.

```
module traffic_example.traffic:
/*
* Traffic light safety protocol
*/
import:
    coreguard.riscv
metadata:
    // Metadata to represent light states
data (Data) NS_T<fixed> = NS_Red
            | NS_Yellow
            | NS_Green
data (Data) EW_T<fixed> = EW_Red
            |EW_Yellow
            |EW_Green
    // Metadata to label code functions
data (Instruction) Transition_T<fixed> = GoGreenNS
                    |GoGreenEW
                    |GoRedNS
                    |GoRedEW
                    |GoYellowNS
                    |GoYellowEW
    // Field declarations
field env : Data
field code : Instruction
    policy:
    signalsafety = transitions & isaExclusions
    transitions =
        rule_1 (code == [+GoGreenNS], env == [NS_Red, EW_Red] -> env =
{NS_Green, EW_Red})
            \hat{ } rule_2 (code == [+GoGreenEW], env == [NS_Red, EW_Red] -> env =
{NS_Red, EW_Green})
            \hat{ } rule_3 (code == [+GoYellowNS] , env == [NS_Green, EW_Red] -> env =
{NS_Yellow, EW_Red})
            \hat{ } rule_4 (code == [+GoYellowEW] , env == [NS_Red, EW_Green] -> env =
{NS_Red, EW_Yellow})
            \hat{ } rule_5 (code == [+GoRedNS], env == [NS_Yellow, EW_Red] -> env =
{NS_Red, EW_Red})
            \hat{ } rule_6 (code == [+GoRedEW], env == [NS_Red, EW_Yellow] -> env =
{NS_Red, EW_Red})
            \hat{ } rule_self(code == [-GoGreenNS, -GoGreenEW,
                              -GoYellowNS, -GoYellowEW,
                              -GoRedNS, -GoRedEW],
                        env == _ -> env = env)
            \hat{ } rule_8 (code == [+GoGreenNS ], env == [+EW_Green] ->
                fail “Safety Violation - East-West Lights Still Green”)
            \hat{ } rule_9 (code == [+GoGreenNS ] , env == [+EW_Yellow]->
                fail “Safety Violation - East-West Lights Still Yellow”)
            \hat{ } rule_10 (code == [+GoYellowNS], env == [+EW_Green]->
                fail “Safety Violation - East-West Lights Still Green”)
            \hat{ } rule_11 (code == [+GoYellowNS], env == [+EW_Yellow]->
                fail “Safety Violation - East-West Lights Still Yellow”)
            \hat{ } rule_12 (code == [+GoGreenEW] , env == [+NS_Green]->
                fail “Safety Violation - North-South Lights Still Green”)
            \hat{ } rule_13 (code == [+GoGreenEW] , env == [+NS_Yellow]->
                fail “Safety Violation - North-South Lights Still
Yellow”)
            \hat{ } rule_14 (code == [+GoYellowEW] , env == [+NS_Green]->
                fail “Safety Violation - North-South Lights Still Green”)
            \hat{ } rule_15 (code == [+GoYellowEW] , env == [+NS_Yellow]->
                fail “Safety Violation - North-South Lights Still
Yellow”)
            \hat{ } rule_16 (code == _, env == [NS_Yellow, EW_Green] ->
                fail “Safety Violation - Neither Set of Lights Is Red”)
            \hat{ } rule_17 (code == _, env == [NS_Green, EW_Yellow] ->
                fail “Safety Violation - Neither Set of Lights Is Red”)
            \hat{ } rule_18 (code == _, env == [NS_Green, EW_Green]->
                fail “Safety Violation - Neither Set of Lights Is Red”)
            \hat{ } rule_19 (code == _, env == [NS_Yellow, EW_Yellow] ->
                fail “Safety Violation - Neither Set of Lights Is Red”)
        require:
```

| | |
|---|---|
| init application.code.function.go_green_EW | {GoGreenEW}:(code) |
| init application.code.function.go_green_NS | {GoGreenNS}:(code) |
| init application.code.function.go_yellow_EW) | {GoYellowEW}:(code |
| init application.code.function.go_yellow_NS | {GoYellowNS}:(code) |
| init application.code.function.go_red_EW | {GoRedEW}:(code) |
| init application.code.function.go_red_NS | {GoRedNS}:(code) |
| init ISA.RISCV.env | {NS_Red, |

EW_Red}:(env)

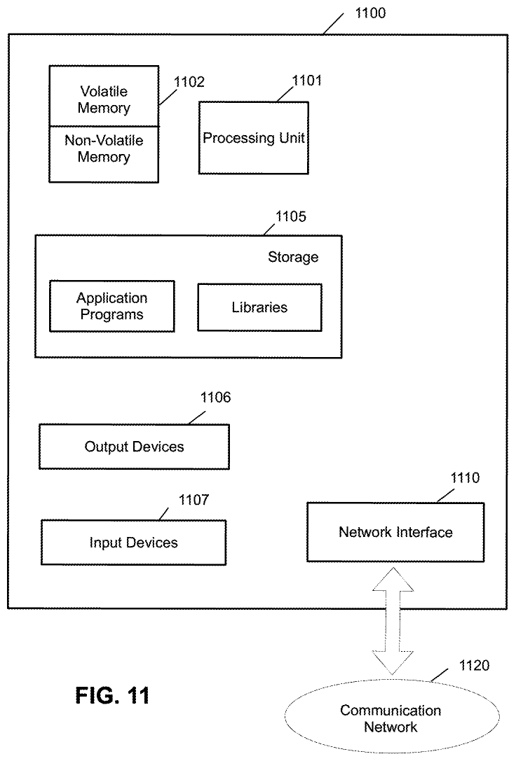

FIG. 11 shows, schematically, an illustrative computer 1100 on which any aspect of the present disclosure may be implemented. In the example shown in FIG. 11, the computer 1100 includes a processing unit 1101 having one or more processors and a computer-readable storage medium 1102 that may include, for example, volatile and/or non-volatile memory. The memory 1102 may store one or more instructions to program the processing unit 1101 to perform any of the functions described herein. The computer 1100 may also include other types of computer-readable medium, such as storage 1105 (e.g., one or more disk drives) in addition to the system memory 1102. The storage 1105 may store one or more application programs and/or resources used by application programs (e.g., software libraries), which may be loaded into the memory 1102.

The computer 1100 may have one or more input devices and/or output devices, such as output devices 1106 and input devices 1107 illustrated in FIG. 11. These devices may be used, for instance, to present a user interface. Examples of output devices that may be used to provide a user interface include printers, display screens, and other devices for visual output, speakers and other devices for audible output, braille displays and other devices for haptic output, etc. Examples of input devices that may be used for a user interface include keyboards, pointing devices (e.g., mice, touch pads, and digitizing tablets), microphones, etc. For instance, the input devices 1107 may include a microphone for capturing audio signals, and the output devices 1106 may include a display screen for visually rendering, and/or a speaker for audibly rendering, recognized text.

In the example of FIG. 11, the computer 1100 may also include one or more network interfaces (e.g., network interface 1110) to enable communication via various networks (e.g., communication network 1120). Examples of networks include local area networks (e.g., an enterprise network), wide area networks (e.g., the Internet), etc. Such networks may be based on any suitable technology, and may operate according to any suitable protocol. For instance, such networks may include wireless networks and/or wired networks (e.g., fiber optic networks). Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing descriptions and drawings are by way of example only.

The above-described embodiments of the present disclosure can be implemented in any of numerous ways. For example, the embodiments may be implemented using hardware, software, or a combination thereof. When implemented in software, the software code may be executed on any suitable processor or collection of processors, whether provided in a single computer, or distributed among multiple computers.

Also, the various methods or processes outlined herein may be coded as software that is executable on one or more processors running any one of a variety of operating systems or platforms. Such software may be written using any of a number of suitable programming languages and/or programming tools, including scripting languages and/or scripting tools. In some instances, such software may be compiled as executable machine language code or intermediate code that is executed on a framework or virtual machine. Additionally, or alternatively, such software may be interpreted.

The techniques disclosed herein may be embodied as a non-transitory computer-readable medium (or multiple non-transitory computer-readable media) (e.g., a computer memory, one or more floppy discs, compact discs, optical discs, magnetic tapes, flash memories, circuit configurations in Field Programmable Gate Arrays or other semiconductor devices, or other tangible computer-readable media) encoded with one or more programs that, when executed on one or more processors, perform methods that implement the various embodiments of the present disclosure discussed above. The computer-readable medium or media may be transportable, such that the program or programs stored thereon may be loaded onto one or more different computers or other processors to implement various aspects of the present disclosure as discussed above.

The terms “program” or “software” are used herein to refer to any type of computer code or set of computer-executable instructions that may be employed to program one or more processors to implement various aspects of the present disclosure as discussed above. Moreover, it should be appreciated that according to one aspect of this embodiment, one or more computer programs that, when executed, perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Program modules may include routines, programs, objects, components, data structures, etc. that perform particular tasks or implement particular abstract data types. Functionalities of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields to locations in a computer-readable medium that convey how the fields are related. However, any suitable mechanism may be used to relate information in fields of a data structure, including through the use of pointers, tags, or other mechanisms that how the data elements are related.

Various features and aspects of the present disclosure may be used alone, in any combination of two or more, or in a variety of arrangements not specifically discussed in the embodiments described in the foregoing, and are therefore not limited to the details and arrangement of components set forth in the foregoing description or illustrated in the drawings. For example, aspects described in one embodiment may be combined in any manner with aspects described in other embodiments.

Also, the techniques disclosed herein may be embodied as methods, of which examples have been provided. The acts performed as part of a method may be ordered in any suitable way. Accordingly, embodiments may be constructed in which acts are performed in an order different from illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” “based on,” “according to,” “encoding,” and variations thereof herein, is meant to encompass the items listed thereafter and equivalents thereof as well as additional items.

1. A computer-implemented method for resolving input patterns into binary representations, comprising acts of:
identifying a plurality of input patterns, wherein an input pattern of the plurality of input patterns comprises a metadata label;
selecting a plurality of respective values for a plurality of variables, wherein the plurality of variables comprise a variable corresponding to the metadata label of the input pattern; and
obtaining a binary representation of the metadata label based on the respective value of the variable.

2. The method of claim 1, wherein:
the method further comprises an act of constructing a plurality of constraints corresponding, respectively, to the plurality of input patterns;
a constraint of the plurality of the constraints corresponds to the input pattern comprising the metadata label;
the constraint references a variable corresponding to the metadata label; and
selecting the plurality of respective values for the plurality of variables comprises solving, subject to the plurality of constraints, for the plurality of variables to obtain the plurality of respective values.

3. The method of claim 2, wherein:
the variable comprises a first variable;
the constraint further references a second variable of the plurality of variables;
the constraint comprises a condition relating the first variable and the second variable.

4. The method of claim 3, wherein:
the condition indicates that the second variable matches a first expression comprising applying a selected hash function to a second expression comprising the first variable.

5. The method of claim 4, wherein:
the method further comprises an act of storing an entry for a concrete rule having the at least one input pattern in a rule cache; and
the entry comprises at least a portion of the respective value of the second variable.

6. The method of claim 5, wherein:
the rule cache comprises a Level 1 (L1) cache and a Level 2 (L2) cache;
the L1 cache has an address space that is smaller than an address space of the L2 cache;
the entry comprises a first entry;
the method further comprises acts of:
obtaining a first address based on the respective value of the second variable, wherein the first entry is stored at a first address in the L1 cache;
obtaining a second address based on the respective value of the second variable; and
storing a second entry for the concrete rule at the second address in the L2 cache.

7. The method of claim 2, wherein:
the variable comprises a first variable;
the plurality of variables further comprise a plurality of second variables;
the constraint comprises a first constraint;
the plurality of variables are solved further subject to a second constraint indicating that the plurality of second variables have pairwise distinct values.

8. The method of claim 2, wherein:
the input pattern comprises a first input pattern;
the method further comprises identifying a second input pattern that is not part of the plurality of input patterns;
the metadata label comprises a first metadata label;
the second input pattern comprises a second metadata label;
the variable comprises a first variable;
the plurality of variables further comprise a second variable corresponding to the second metadata label;
the plurality of variables further comprise a plurality of third variables;
the constraint comprises a first constraint;
the plurality of variables are solved further subject to a second constraint indicating that none of the plurality of second variables matches a first expression comprising applying a selected hash function to a second expression comprising the second variable.

9.-18. (canceled)

19. A computer-implemented method for resolving metadata labels into binary representations, comprising acts of:
looking up a metadata label in a dictionary, the dictionary comprising a plurality of entries mapping metadata labels to respective binary representations;
if the metadata label matches an entry in the dictionary, obtaining a binary representation to which the matching entry maps the metadata label; and
if the metadata label does not match any entry in the dictionary, generating a new binary representation.

20. The method of claim 19, wherein:
the metadata label does not match an entry in the dictionary; and
the method further comprises an act of adding an entry to the dictionary, the entry mapping the metadata label to the new binary representation.

21. The method of claim 19, wherein:
the method further comprises an act of maintaining a counter that counts a number of binary representations that have been generated; and
the new binary representation comprises a binary string representing a value of the counter.

22. The method of claim 19, wherein:
the metadata label comprises a list of one or more metadata symbols.

23. The method of claim 22, wherein:
the list of one or more metadata symbols is sorted according to a selected ordering of metadata symbols.

24. The method of claim 22, further comprising an act of:
incrementally adding the one or more metadata symbols to the list as one or more policies are evaluated, the one or more policies referencing the one or more metadata symbols.

25. The method of claim 19, wherein:
the dictionary comprises a hash table; and
looking up the metadata label in the dictionary comprises:
applying a hash function to the metadata label; and
if the metadata label is hashed to a non-empty bucket, determining whether the metadata label matches an entry in the non-empty bucket.

26. The method of claim 19, wherein:
the dictionary comprises a graph;
the plurality of entries in the dictionary comprise a plurality of nodes in the graph; and
looking up the metadata label in the dictionary comprises traversing the graph to identify a node that matches the metadata label.

27.-28. (canceled)

29. A computer-implemented method for identifying input patterns, comprising an act of:
processing a policy rule to identify at least one input pattern, wherein:
the policy rule comprises at least one condition on at least one input;
the at least one input pattern comprises at least one metadata label corresponding to the at least one input; and
the at least one metadata label satisfies the at least one condition on the at least one input.

30. The method of claim 29, wherein:
the at least one metadata label comprises a subset of a set of metadata symbols; and
processing the policy rule to identify the at least one input pattern comprises selecting the subset from the set of metadata symbols.

31. The method of claim 30, wherein:
selecting the subset from the set of metadata symbols comprises identifying an assignment of truth values to metadata symbols in the set of metadata symbols;
an assignment of 1 to a metadata symbol indicates the metadata symbol is in the subset; and
an assignment of 0 to a metadata symbol indicates the metadata symbol is not in the subset.

32. The method of claim 31, wherein:
identifying the assignment of truth values to the metadata symbols comprises identifying an assignment that satisfies one or more constraints.

33.-44. (canceled)
